(19) United States
(12) Patent Application Publication
(10) Pub. No.: US 2003/0004829 A1
(43) Pub. Date: Jan. 2, 2003

(54) Multi-provider funeral plan web site and administration thereof

(75) Inventors: Efrain Torres, Cincinnati, OH (US); Rachel Elizabeth Myers, Cincinnati, OH (US); Shannan Kristine Aylor, Cincinnati, OH (US); Dennis L. Siebert, Sunman, IN (US)

Correspondence Address: WOOD, HERRON & EVANS, L.L.P., 2700 Carew Tower, 441 Vine St., Cincinnati, OH, 45202, US

(73) Assignee: Forethought Financial Services, Inc.

(21) Appl. No.: 10/119,208

(22) Filed: Apr. 9, 2002

Related U.S. Application Data
(60) Provisional application No. 60/282,636, filed on Apr. 9, 2001.

(51) Int. Cl. G06F 17/60

(52) U.S. Cl. 705/26

(57) ABSTRACT

Internet-based technology is utilized to provide a funerary-related web site such as a funeral planner web site for use in planning a funeral or other memorial service online on behalf of one or more funerary service providers such as funeral homes. Custom-tailored web sites are supported for multiple funerary service providers, with a significant degree of customization supported for both look and feel and provider-specific product and service offerings. Moreover, through the use of several unique administration functions, self-configuration of a funerary service provider's custom web site is facilitated, even for users having limited computer and Internet skills.

### CROSS-REFERENCE TO RELATED APPLICATIONS

This application claims the benefit of U.S. Provisional Patent Application Serial No. 60/282,636, filed Apr. 9, 2001. Moreover, this application is related to U.S. patent application Ser. No. 09/827,803, filed Apr. 6, 2001, which claims the benefit of U.S. Provisional Patent Application Serial No. 60/216,567, filed Jul. 7, 2000. The disclosures of all of these applications are incorporated by reference herein.

### FIELD OF THE INVENTION

The invention relates generally to the death care industry, and more particularly to funerals and other memorial services and methods of planning the same.

### BACKGROUND OF THE INVENTION

Upon the death of a family member, surviving loved ones must make a number of decisions in a relatively short time. Too often a bereaved loved one feels pressured and overwhelmed by memorial preparations. Exemplary memorial decisions encompass ceremony preferences, financial arrangements, casket or urn selections, etc. Other considerations relate to transportation, floral displays, as well as “personalizing” products and services. For instance, clients routinely customize materials, finishes, corner adornments and interiors of caskets to honor loved ones. Likewise, “memorial items” or keepsakes may be tastefully incorporated into aspects of a memorial service. While such services and personal touches facilitate the healing processes, they often represent difficult choices for bereaved loved ones.

In consideration of the above, the trend of preplanning one's own funeral has become increasingly common. Preplanning ensures that the wishes of a planner are recorded and fulfilled. The practice is especially desirable in discordant family scenarios where children may pointedly disagree as to memorial details. Thus, death care providers expend great resources to develop methods and products to encourage and facilitate preplanning.

Funeral plans and preplans are conventionally created in an “arrangement conference.” In such a conference, a funeral director meets with a pre-planner or surviving loved one of the deceased. The conference is typically held in the funeral home of the funeral director, who describes and discusses various funeral products, services and costs. The funeral director may use visual aids, such as a product catalog, product display board and a casket selection room to illustrate the products available to the customer. Similar catalogs may be employed to give a sense for the services offered by a funeral.

While many family members and pre-planners prefer the structure and personal attention of an arrangement conference, others are uncomfortable meeting a funeral director in person. Some clients may feel pressured in a personal interview, or even concerned that they are wasting a director's time with indecisiveness. The demanding schedules of other clients do not allow for adequate time to meet with a funeral director or research arrangements thoroughly. Still other clients struggle with the initial decision of choosing a funeral home suited to meet their unique needs.

Some death care providers attempt to meet client insecurities and busy schedules by tapping into Internet resources. Commercial Internet applications have become ubiquitous in nearly every other industry, and funerary providers likewise recognize advantages inherent to the technology. For instance, digitized listings of funeral products and services are displayed on Internet web pages maintained by funeral suppliers and providers. Such web pages allow browsers limited exposure to select products and other aspects of a memorial process. Web pages can familiarize clients with select products and services prior to an arrangement conference. However, while they can facilitate the planning process, conventional web sites are often not comprehensive or integrated and often still require clients to attend personal arrangement conferences.

It would be preferable for many individuals, if given the option, to be able to pre-plan their funeral and associated arrangements online. Moreover, it has been found that many customers are often confused and wary of the costs associated with funerals and the like, and would prefer to be able to learn more about potential costs. However, to date the online planning options for such individuals are extremely limited. One significant obstacle to the incorporation of Internet technologies into funeral planning, and into the death care industry in general, is the limited resources and technical sophistication of many funeral homes and other funerary service providers. Family-owned funeral homes, in particular, often lack the financial resources to develop, maintain or host extensive web sites with advanced electronic commerce capabilities.

In other industries, smaller enterprises lacking the resources to develop and create their own custom web sites may be able to rely on “portal” web sites that assist with various electronic commerce functions and serve as “virtual storefronts.” Many such web sites support functions such as product browsing, order processing, credit card processing, etc. on behalf of their business customers, and many provide various administration tools to permit customers to create custom-look web sites without significant Internet development experience. In many instances, customers are permitted to upload custom product catalogs, and perform other functions such as create custom catalogs online through a web interface.

While online shopping portals often serve the electronic commerce needs of many types of small businesses, in many instances these portals lack some of the capabilities that would be advantageous for businesses that inherently are location-specific in nature, and in particular, for funeral homes and other funerary service providers. For example, the funeral planning process is often complex, with a multitude of decisions and selections needed from a customer, and with many decisions or selections necessarily limiting or expanding the types of future decisions that need to be made to complete a funeral plan. Online shopping portals typically support, at most, the provision of electronic “shopping carts” that customers may place items in for purchase. Such shopping carts are incapable, however of effectively guiding a customer through the myriad of options and decisions that are required to create a comprehensive funeral plan.

Therefore, a significant need continues to exist in the art for an improved manner of developing, supporting and administering Internet content on behalf of funerary service providers.

### SUMMARY OF THE INVENTION

The invention incorporates Internet-based technology to provide a funerary-related web site such as a funeral planner web site for use in planning a funeral or other memorial service online on behalf of one or more funerary service providers such as funeral homes. Custom-tailored web sites may be supported for multiple funerary service providers, with a significant degree of customization supported for both look and feel and provider-specific product and service offerings. Moreover, through the use of several unique administration functions, self-configuration of a funerary service provider's custom web site is facilitated, even for users having limited computer and Internet skills.

Consistent with one aspect of the invention, funerary service providers such as funeral homes may develop and maintain provider-specific provider catalogs that include, in part, a subset of funerary items from a common database that is shared by multiple such providers. In addition to identifying unique subsets of funerary items, each provider catalog may also incorporate provider-specific pricing information.

Consistent with another aspect of the invention, funerary service providers that incorporate an organizational structure with multiple entities, e.g., multiple funeral homes owned and/or operated by a funeral home company, may utilize “branding groups” used to provide a custom and feel of a web site through a unique display configuration associated with each branding group. Specific entities are assigned to particular branding groups, such that display configuration information is shared by all of the entities assigned to the same branding group.

Consistent with yet another aspect of the invention, funerary service providers that incorporate an organizational structure with multiple entities may utilize “catalog groups” used to provide custom provider catalogs, and thus custom offerings, and optionally, custom pricing information, for each catalog group. Specific entities are assigned to particular catalog groups, such that item offering information displayed to customers will be custom tailored for each particular entity on a group by group basis.

Consistent with another aspect of the invention, a configurable user interface may be provided to facilitate administration of profile information for a funerary services provider such as a funeral home company. An authorized user of a funeral home company, for example, may be presented with company structure options to select among individual, collective, or group-based administration of profile information on behalf of a plurality of funeral homes owned and/or operated by the funeral home company. Based upon that user's selection, one of three different administration web pages may then be displayed to that user, facilitating administration of the profile information in a manner appropriate to the selected option.

Consistent with a further aspect of the invention, an exclusion criterion may be associated with a funerary service provider to limit search results obtained during a funeral home search to exclude other providers meeting the exclusion criterion. As an example, an exclusion criterion may be used to exclude providers having the same state, ZIP code, or area code as a particular provider.

Consistent with an additional aspect of the invention, a package may be associated with a funerary service provider, specifying a subset of items from a database, as well as a package price associated with the subset of items. Customers may then have the ability to select packages of funerary products and/or services instead of always requiring ala carte selection of individual funerary items, often substantially simplifying the selection of items during creation of a funeral plan.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a computer system for hosting and administering multiple funerary service provider-specific funeral planning web sites to a plurality of customers in a manner consistent with the invention.

FIG. 2 is a block diagram illustrating a functional representation of an exemplary home page from a funerary service provider web site referenced in FIG. 1.

FIG. 3 is a block diagram of an exemplary hardware and software implementation of the funeral plan server of FIG. 1.

FIG. 4 is a block diagram illustrating an exemplary database organization for the database of FIG. 3.

FIG. 5 is a block diagram illustrating an exemplary administration web site organization implemented by the B2B administration program code of FIG. 2.

FIG. 6 is a block diagram of a set company structure web page accessible from the administration web site of FIG. 5.

FIG. 7 is a block diagram illustrating an exemplary implementation of the administration page of FIG. 5, for use with an individual funeral home.

FIG. 8 is a block diagram illustrating an exemplary implementation of the administration page of FIG. 5, for use with a multi-funeral home funeral home company in which each funeral home has a unique profile.

FIG. 9 is a block diagram illustrating an exemplary implementation of the administration page of FIG. 5, for use with a multi-funeral home funeral home company in which all funeral homes share the same profile.

FIG. 10 is a block diagram illustrating an exemplary implementation of the administration page of FIG. 5, for use with a multi-funeral home funeral home company in which brand and catalog groups have been established.

FIG. 11 is a block diagram illustrating an exemplary product catalog administration product list web page accessible from the web site of FIG. 5.

FIG. 12 is a block diagram illustrating an exemplary product catalog administration offering edit web page accessible from the product catalog administration product list web page of FIG. 11.

FIG. 13 is a block diagram illustrating an exemplary product catalog administration add offering web page accessible from the product catalog administration product list web page of FIG. 11.

FIG. 14 is a block diagram illustrating an exemplary service catalog administration add offering web page accessible from an edit services catalog link in the administration web site of FIG. 5.

FIG. 15 is a block diagram illustrating a product catalog administration edit price web page accessible from the administration web site of FIG. 5.

FIG. 16 is a block diagram illustrating a service catalog administration edit price web page accessible from the administration web site of FIG. 5.

FIG. 17 is a block diagram illustrating an exemplary customize appearance web page accessible from the administration web site of FIG. 5.

FIG. 18 is a block diagram illustrating an exemplary create/edit group web page accessible from the administration web site of FIG. 5.

FIG. 19 is a block diagram illustrating an exemplary assign locations to group web page accessible from the administration web site of FIG. 5.

FIG. 20 is a block diagram illustrating an exemplary customize funeral home finder results web page accessible from the administration web site of FIG. 5.

FIG. 21 is a flowchart illustrating the program flow of a funeral home search routine executed by the funeral planner program code of FIG. 3.

FIG. 22 is a block diagram illustrating an exemplary edit packages web page accessible from the administration web site of FIG. 5.

FIG. 23 is a block diagram illustrating an exemplary add/edit package web page accessible from the edit packages web page of FIG. 22.

FIG. 24 is a block diagram illustrating an exemplary add product to package category web page accessible from the add/edit package web page of FIG. 23.

FIG. 25 is a block diagram illustrating an exemplary add service to package category web page accessible from the add/edit package web page of FIG. 23.

FIG. 26 is a block diagram of a package selection web page generated by the funeral planner program code during preparation of a funeral plan by a customer.

### DETAILED DESCRIPTION

The embodiments discussed hereinafter support the ability to dynamically generate and serve web pages on behalf of a plurality of funerary service providers, in effect providing an Internet presence and facilitating e-commerce capabilities for multiple funerary service providers. In addition, the embodiments discussed hereinafter support a number of unique tools capabilities to facilitate the management and administration of the system by individual funerary service providers, particularly those with limited computer skills. In the context of the invention, a funerary service provider may be any individual or entity providing a death care-related product and/or service, including without limitation funeral home companies, cemeteries, third party pre-need sellers, etc. In the embodiments discussed hereinafter, funeral home companies, or simply funeral homes, are utilized as exemplary funerary service providers. However, it will be appreciated that the invention is not limited for use solely with funeral home companies.

### Overview

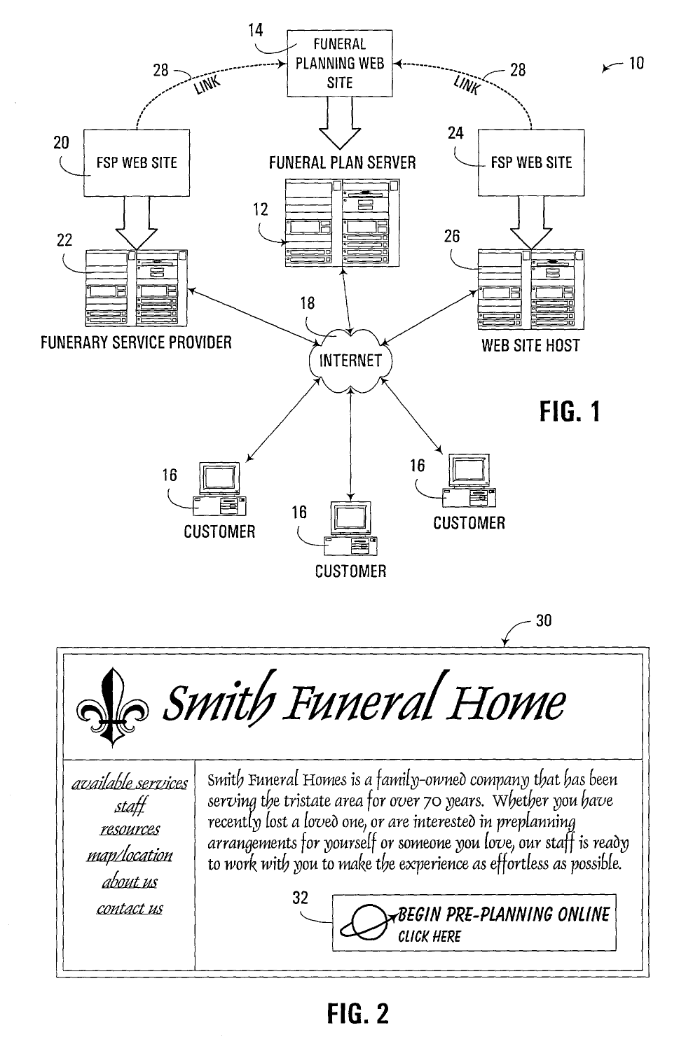

Now turning to the drawings, wherein like numbers denote like parts throughout the several views, FIG. 1 illustrates a multi-provider funeral home web site computer system 10 consistent with the invention. System 10 includes at least one apparatus, e.g., one or more funeral plan servers 12 suitable for serving a funeral planning web site 14 to a plurality of customers 16 over a network such as the Internet 18. Funeral planning web site 14 is customized by server 12 on behalf of a plurality of funerary service providers, here funeral homes, to provide a custom-tailored browsing experience for a customer based upon the desires of the particular funeral home with which such customers are interacting.

In the illustrated embodiment, funeral planning web site 14 is integrated with another web site utilized by each funeral home served by the system. A funeral home web site may be served by funeral plan server 12, or in the alternative, may be served by another computer coupled to server 12 over the Internet. For example, a funeral home web site 20 may be served by a server 22 owned and operated by a funerary service provider. In the alternative, a funeral home web site such as web site 24 may be hosted on behalf of a funeral home by an Internet service provider or web site host 26.

The funeral planning functionality supported by server 12 is typically invoked by a user via a link 28 from the funeral home web site with which the user in interacting. For example, as shown in FIG. 2, an exemplary home page 30 for a funeral home is shown, with a link 32 that directs the user to a funeral planning web site hosted by funeral plan server 12.

The funeral planning functionality of server 12 is described in greater detail in U.S. patent application Ser. No. 09/827,803, filed Apr. 6, 2001 by Efrain Torres et al., and entitled “System and Method of Planning a Funeral,” the disclosure of which is incorporated by reference herein. As described in the referenced application, a customer may be permitted to generate a custom funeral plan through a number of mechanisms, selecting various pre-planning arrangements such as burial and cremation options, ceremony options, family and friend options, personalization options, etc. to assist a loved one in planning a funeral upon the death of the subject of the funeral plan. In addition, during the generation of a funeral plan, a funeral home may be selected, and moreover, funeral-related services and/or products may be selected by a user, with the potential for estimated prices to be supplied to the user at that time. Such pricing may even be guaranteed, or pre-payment may be supported to further minimize the degree of planning and expense at the time of death.

In the illustrated embodiment, both funeral home-specific interfaces, as well as a generic interface, are supported by the funeral planning system so that users may either start out with a specific funeral home in mind, or select from a number of available funeral homes after funeral planning has begun. As such, server 12 of FIG. 1 is also configured to support a generic user interface during funeral planning by a customer. In addition, as will be discussed in greater detail below, whenever a particular funeral home has been selected, the user interface may be custom-tailored to utilize profile information about that funeral home to custom-tailor the look and feel, as well as the product and service offerings made available to the customer, based upon the profile information of the selected funeral home.

Server 12 is configured to support those customers that initially start the funeral planning operation by contacting the server directly, e.g., at a particular web address associated with the server. In addition, to provide a custom interface for each funeral home supported by the server, the server is also configured to permit customers to be forwarded to the server after initially contacting a particular funeral home web site. Various techniques, known in the art, may also be utilized as well to disguise from the customer the fact that the customer has been redirected away from the funeral home web site that customer originally contacted. For example, hidden frames, or frames have sizes of only a few pixels may be utilized to maintain the primary web address of a page to be that of a funeral home web site, with a frame within that frame redirected to the funeral planning web site hosted by server 12.

While the discussion hereinafter will focus on funeral planning, it will be appreciated that the techniques described herein may have applicability in other contexts to support the electronic commerce needs of funerary service providers. For example, additional electronic commerce functions such as taking and placing orders for products and services, advertising, statistics tracking, etc. may also be supported by server 12. Moreover, as mentioned above, a funeral home web site may be entirely hosted by server 12, whereby links from an external web site would not be required. Other ancillary services such as financial planning, insurance, etc., may also be supported by server 12 consistent with the invention. Therefore, the invention is not limited to the particular embodiments discussed herein.

Hardware and Software Environment

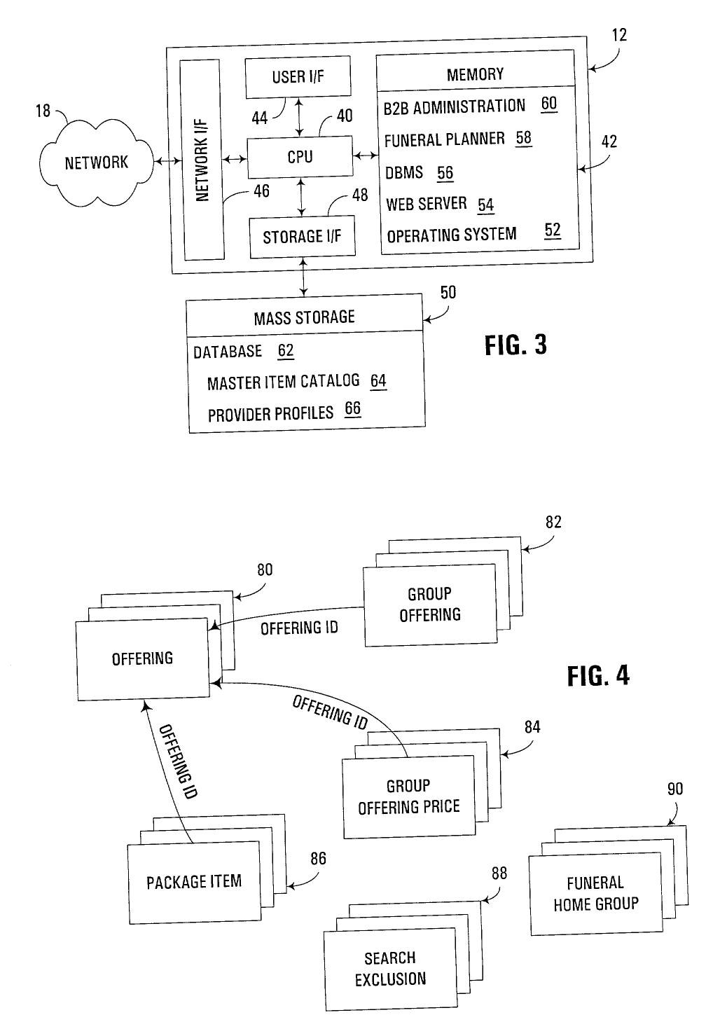

One specific hardware and software implementation of server 12 is illustrated in FIG. 3. Server 12 typically includes a central processing unit 40 including one or more microprocessors coupled to a memory 42, which may represent the random access memory (RAM) devices comprising the main storage of server 12, as well as any supplemental levels of memory, e.g., cache memories, non-volatile or backup memories (e.g., programmable or flash memories), read-only memories, etc. In addition, memory 42 may be considered to include memory storage physically located elsewhere in server 12, e.g., any cache memory in a processor in CPU 40, as well as any storage capacity used as a virtual memory, e.g., as stored on a mass storage device 50 or on another server coupled to server 12. Server 12 also typically receives a number of inputs and outputs for communicating information externally. For interface with a user or operator, server 12 typically includes a user interface 44 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, and is more typical for a server-type computer, user input may be received via another computer or terminal, whereby user interface 44 may be a terminal or workstation interface. Furthermore, in many instances user input may be received via network 18 over a network interface 46, e.g., where an web-type management interface is supported by the computer.

For additional storage, server 12 may also include a storage interface 48 to one or more mass storage devices 50, e.g., a floppy or other removable disk drive, a hard disk drive, a direct access storage device (DASD), an optical drive (e.g., a CD drive, a DVD drive, etc.), and/or a tape drive, among others. Mass storage may also be supported in a networkable storage device such as network addressable storage (NAS) or a storage area network (SAN). Furthermore, server 12 may include an interface 46 with one or more networks (e.g., a LAN, a WAN, a wireless network, and/or the Internet, among others) to permit the communication of information with other computers and electronic devices.

Server 12 operates under the control of an operating system 52 and executes or otherwise relies upon various computer software applications, components, programs, objects, modules, data structures, etc. Moreover, various applications, components, programs, objects, modules, etc. may also execute on one or more processors in another computer coupled to server 12 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

Administrative Functionality

To support the hosting of custom-tailored web pages on behalf of a plurality of funeral homes, server 12 supports, in addition to the serving of web pages, various back-end or administrative capabilities permitting funeral homes or individuals associated therewith to administer various customization options available for their custom-tailored web sites. Various manners of supporting back-end services to funeral homes may be supported consistent with the invention. In the illustrated embodiment, for example, a web-based interface is provided, whereby a back-end or B2B (business-to-business) web site is supported such that funeral homes may connect to server 12 over the Internet, authenticate using known security technologies, and change various settings through a web-based interface. Other manners of interfacing with server 12 may be used in the alternative, e.g., direct dial-up connections, specialized applications, email, etc.

A discussion of the various administrative functions made available to funeral homes will be provided prior to a discussion of the generation of custom-tailored web pages to customers. As discussed above, in many instances, representatives of funeral homes may have limited computer skills, and as such, a number of capabilities are supported by the server to facilitate the customization process. One such function is the support for custom product and service catalogs. As will be described in greater detail below, funeral home representatives are able to select items from a master offerings database for inclusion in funeral home-specific products and services catalogs. Moreover, pricing information is individually maintained for each funeral home so that custom price lists may be generated for those products and/or services selected by a funeral home for inclusion in its catalog. In addition, it may be desirable to support the inclusion of additional products and/or services not included in the master database.

Another function supported by server 12 is the ability to select a customized look and feel for the funeral home-specific web site, e.g., through the selection of customized color schemes and/or the addition of logos or other descriptive text specific to a funeral home.

Yet another function supported by server 12 is that of facilitating the management of multiple entities, e.g., funeral homes, owned or controlled by the same funerary service provider, e.g., a funeral home company. In this regard, support for branding and catalog groups permits individual funeral homes owned or operated by the same funeral home company to be associated with specific looks and feels and product/service catalogs based upon membership in different groups set up by a funeral home. Doing so may facilitate the definition of different marketing strategies for various funeral homes, including, for example, discount and premium brands, including different price lists and catalog selections. In connection with the support of groups, a configurable user interface may also be supported to custom-tailor the administration functions available to a funeral home based upon the business structure of a funeral home company.

Yet another function supported by server 12 is that of customizing a funeral home location search based upon the preferences of a particular funeral home. In particular, when a customer is planning a funeral after initially contacting a particular funeral home web site, a funeral home may be concerned that any funeral home location functionality in the funeral planning web site may direct that user to one of its competitors. As such, search exclusion options may be made available to funeral homes to effectively “lock-out” competitors in close geographical proximity whenever a customer is performing funeral planning under the auspices of that funeral home's custom-tailed funeral planning web site.

Yet another function supported by server 12 is that of the creation of packages of products and services. Packages may be associated with particular discounts, with offerings of complete packages supplied to customers when developing a funeral plan, thus simplifying the selection of a menu of products and services by a customer.

Additional functions supported by server 12 will become more apparent from the discussion presented hereinafter.

Software Organization

Various software components are supported in server 12 to provide the aforementioned functions. Shown resident in memory 42, for example, is an operating system 52, as well as a web server 54, database management system 56, funeral planner program code 58 and B2B administration program code 60. Web server 54 and database management system 56 may be implemented using off-the-shelf products to simplify design, with program code 58 and 60 custom designed to support the functions described herein. In this regard, program code 58 and 60 may be implemented using a number of development languages, including, for example, java server pages (JSP's).

Also shown in mass storage 50 is a database 62 including a master item catalog, or offerings database 64 and one or more provider profiles 66. Master item catalog 64, which may be implemented to provide separate product and service databases (products and services will be collectively referred to as “items” in the discussion hereinafter), or all such items may be integrated into the same catalog.

Provider profiles 66 include at least a portion of the customization information necessary for supporting a particular funeral home and thereby generate a custom-tailored web site therefor. It will be appreciated that separate databases may be utilized for catalog 64 and profiles 66, and that various information in the profiles may be stored in multiple databases. The precise organization of both the program code implementing the various functions described herein, as well as the data relied upon by such program code in one or more databases, may vary in different embodiments. Therefore, the invention is not limited to the particular embodiments discussed herein.

Database Organization

FIG. 4 illustrates the principal tables in database 62 for storing both the master item catalog 64 and provider profiles 66 of FIG. 3. Specifically, the master item catalog is principally stored in an offering table 80, while the profile information is 30 principally stored in a group offering table 82, group offering price table 84, package item table 86 search exclusion table 88, and funeral home group table 90. Funeral homes are associated with both a funeral home ID (unique for every funeral home location) and one or more group ID's, which are used by server 12 to select profile-specific information for the funeral home. Group ID's are defined for both brand and catalog groups, and funeral home group table 90 is used to map funeral home ID's to brand and/or catalog group ID's as appropriate. As such, table 90 is typically accessed whenever branding or provider catalog information needs to be accessed on behalf of a particular funeral home.

The offering table 80 is a master list of all the funerary items (products and/or services) capable of being included in a funeral home catalog, and includes various fields such as a unique ID, category (used to classify offerings into different classes, e.g., caskets, urns, etc.), default price, description, main and thumbnail graphics, material, model name and number, etc. Additional information, e.g., creation and modification logs, etc., may also be incorporated into each offering record stored in table 80. Offering table 80 may have other uses than in supplying products and services to the funeral planning web site. For example, offering table 80 may be used by a funerary products manufacturer as its master product list for manufacturing, sales, shipping, etc.

The group offering table 82 incorporates the list of funerary items assigned to each particular catalog group ID. Records may be linked to an item in offering table 80 via the ID used in the offering table, or in the alternative, the data in the offering table may be copied into the group offering table should no persistent link to the offering table be desired. In addition, custom, or provider-specific, funerary items, may also be incorporated into table 82, with no link to a corresponding item in offering table 80. One exemplary format for the group offering table 82 is shown in Table I below:

TABLE I
Group Offering Table

| FIELD | DESCRIPTION |
|---|---|
| GROUP_ID | Group ID |
| OFFERING_ID | Link to Offering in Offering Table |
| OFFERING_CLASS | Product or service |
| CSC_ID | Manufacturer customer ID |
| DISPLAY_SAVINGS_IND | Flag to display the applied discount |
| DESCRIPTION | Description to display to customer |
| UOM | Unit of Measure |
| ON_GPL_IND | Flag to include on FH general price list |
| DISPLAY_IND | Flag to display separate from package |
| GUAR_IND | Flag for guaranteed price |
| TXBL_IND | Flag for taxable status |
| ST_TX_RT | Applicable state tax rate |
| CO_TX_RT | Applicable county tax rate |
| CTY_TX_RT | Applicable city tax rate |
| OTHR_TX_RT | Applicable other tax rate |
| ACTIVE_IND | Active status flag |
| ACTIVE_DATE | Date record was made active |
| MODEL_NAME | Model name of product/service |
| MODEL_CD | Model number |
| ORIGINAL_SKU | SKU |
| CREATED_TMS | Timestamp of when created |
| CREATED_BY | User who created record |
| LAST_MODIFIED_TMS | Timestamp of when last modified |
| LAST_MODIFIED_BY | User who last modified |
| RATING | Rating for an item or package |
| ORG_ID | Manufacturer name |

Group offering price table 84 stores price records keyed to both offering ID and group ID. Given that it may be desirable to store different prices, e.g., for different times of the year, or in other circumstances, multiple price records may be associated with a given funerary item in a catalog. In other embodiments, however, only one price may be supported, whereby many of the field in the offering price records could be incorporated into a group offering record. One exemplary format for the offering price table 84 is shown in Table II below:

TABLE II
Offering Price Table

| FIELD | DESCRIPTION |
|---|---|
| GROUP_ID | Group ID |
| OFFERING_ID | Link to Offering in Offering Table |
| CHANGE_NUM | Number of times prices has changed |
| START_DATE | Start date of price |
| END_DATE | End date of price |
| UNIT_PRICE | Unit price |
| MIN_MULTIPLIER | Minimum number of an offering |
| MIN_COUNT | Minimum number of units |
| UOM | Units of measure |
| CHANGE_TYPE_CD | Type of change (permanent/temporary) |
| CREATE_DATE | Creation date of record |
| LAST_MODIFIED_DATE | Date of last modification |
| CREATED_BY | Person who created record |
| LAST_CHANGED_BY | Person who last modified record |
| P_MULTIPLIER | Percent discount |
| P_ADDEND | Dollar discount |
| NO_CHARGE_IND | Flag for no charge |
| ACTUAL_START_DATE | Date price is effective |
| ACTUAL_END_DATE | Date price expires |
| ACTIVE_IND | Flag for active status of record |
| B2B_DELETED_FLAG | Flag for deleted item |
| ROUND_NEAREST | Rounding rule |

Package item table 86 is used to represent packages of products and services. Each record in table 86 includes a group ID field, an offering ID field and an item offering ID field. The group ID field stores the group with which the package is associated. In addition, whenever a package is created, a new record is inserted into the group offering table 82 to represent the package, and the offering ID field for all items in that package is set to link to this new record. The item offering ID field stores an offering ID to an item to be included in this package. It will also be appreciated that, since the package itself is represented in the group offering table, a group offering price record will typically be associated with the group offering record of the package to store a price for the package.

Search exclusion table 88 stores search exclusion rules used by a funeral home to restrict the search results of a funeral home search in a geographical area proximate that funeral home. Each record in table 88 includes a group ID to link the rule to a particular group, a rule number field uniquely identifying the rule, a field name that identifies the type of restriction (i.e., ZIP code, area code, state), operation and value fields that define the test against the field name, and a CLUDE field that sets the rule to “include” or “exclude” matching funeral homes.

It will be appreciated that profile information for a funerary services provider may be stored in any number of provider profile data structures, and may include any number of substructures distributed across multiple databases and/or tables. Given the multitude of manners in which data may be represented in a computer, the invention should not be limited to the particular provider profile data structures disclosed herein.

Profile Information Usage Overview

As mentioned above, profile information for a particular funeral home is utilized in the context of customizing the look and feel of a funeral planner web site, and in customizing the product and/or service offerings capable of being selected by a customer when creating a funeral plan. In this regard, in the illustrated embodiment, whenever the funeral planner web site is accessed from a funeral home web site, the URL that links to the funeral planner site should include a brand group ID and an optional funeral home ID, e.g., having a format such as “http://www.funeral-home-planner.com?groupID=xxx&fhId=yyy”. When accessed, the funeral planner program code may look for a directory on the server with the name of the brand group ID, and if that directory exists, properties may be loaded from a file in that directory that has customization settings in it for such things as the custom logo to be displayed (which also resides in that directory) and the title of the page. Also, if a funeral home ID is specified in the URL, a fresh funeral plan may be created and the funeral home corresponding to the ID passed is set as the funeral home for the plan.

The brand group ID directory may also contain a custom style sheet for the group in question. The style sheet may incorporate the colors and “look and feel” for the funeral homes in the specified group to be used in all subsequent pages. In the portion of the funeral planner program code that builds the pages, a variable for the style sheet is set to point to that in the associated directory. Whenever a customer contacts the funeral planner web site directly, the variable may reference a generic or standard style sheet.

Regardless of whether the funeral planner web site is contacted directly or through a funeral home web site, it is typically necessary, prior to selecting any products or services in connection with the plan, to select a funeral home. Once selected, a catalog group ID of the funeral home may be used to load the catalog that has been set up for the funeral home into memory from the database. Then, when it comes time for the customer to select a casket or some other item, the customer may be presented with a list of caskets (or whatever item is being reviewed) that has been set up by the funeral home they have chosen. Whenever a customer clicks on either of “Professional Services” or “Products” links, a query may be run against the database, and all the products and services that the funeral home has set up may be loaded. All products and services are keyed off the catalog group ID of the funeral home selected in the funeral home finder. The user can then browse the catalog that corresponds to the funeral home they have selected.

### Web Site Administration

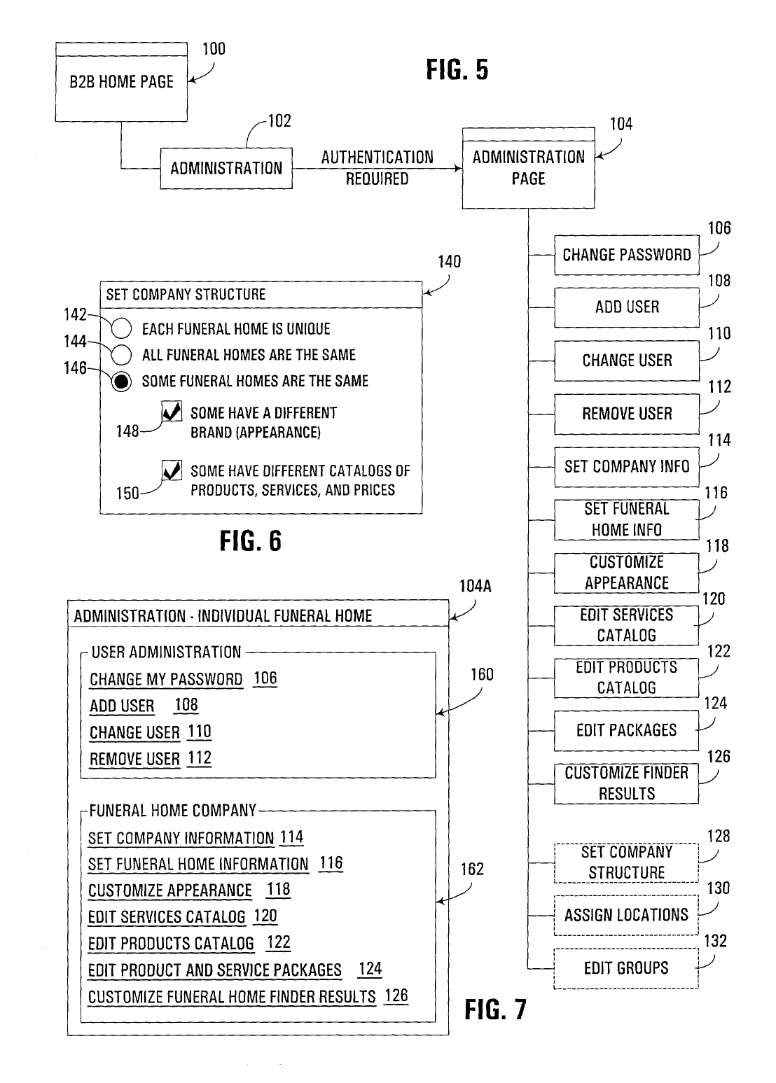

FIG. 5 illustrates an overall flow of interaction by a user in an administration role. As such, a user in this context is typically an authorized representative of a particular funeral home. As shown in FIG. 5, a user would typically browse initially to a B2B home page 100 which may be set to a specific domain, or in the alternative, may be accessible from the overall funeral planner web site via a link. Included among other information on home page 100 is an administration link 102 which, when activated by a user, navigates the user to an administration page 104. In addition, some form of authentication, such as entering a user name and password, or other manners of authentication as known in the art, may be utilized to control access to an administration page 104.

Included on administration page 104 are a plurality of links 106-126, as well as a number of optional links 128-132 that are displayed only in certain instances based upon the type of funeral home company organizational structure for the user accessing the administration page.

A change password link 106 is used to update the password for a particular funeral home company. Add user link 108, change user link 110 and remove user link 112 are respectively used to add, modify and remove authorized users to the account for a particular funeral home company. All of such links will generally open new web pages providing input forms for editing the user information for a particular funeral home company. Maintained for each user may be various information, e.g., user ID, first and last name, email address, agent ID, administration privileges, report privileges, etc. Moreover, such privileges may vary for different funeral homes owned by a given funeral home company.

Set company info link 114 and set funeral home info link 116 are respectively used to manage various information about a funeral home company and its individual funeral homes, and will generally be used to open new web pages providing input forms for such information. Information such as legal name, display name, street address, mailing address, telephone numbers, web site addresses, contact information, etc. may be stored for each funeral home company and funeral home.

Customize appearance link 118 is used to modify the look and feel of a funeral home's custom-tailored web site, while edit services catalog link 120 and edit products catalog link 122 are used to edit the product/services offerings for a particular funeral home company. Edit packages link 124 is used to create or edit packages of predetermined products and services, and customize finder results link 126 is used to specify funeral home-specific search exclusion rules. The functions initiated by selection of each of links 118-126 are discussed in greater detail hereinafter.

Set company structure link 128 is used to configure the stored company structure for a funeral home company. As discussed above, the user interface presented to a funeral home representative may vary depending upon the organizational structure set up for the company. The organizational structure for a company may be set up initially by an administrator of server 12 during setup of a new account, or in the alternative, may be custom configured by a funeral home representative, either upon initial creation of an account or later via selection of link 128 via administration page 104.

FIG. 6, for example, illustrates a “set company structure” web page 140 presented to a funeral home representative in response to selection of link 128 in FIG. 5. Web page 140 may also be presented to a funeral home representative or server administrator during initial setup of an account for the funeral home company. Web page 140 is generally made available to any funeral home company having more than one funeral home, and is used to control how profile information will be mapped to specific funeral homes owned by the same funeral home company.

Three primary funeral home company organizational structures are supported for funeral home companies that own and/or operate multiple funeral homes or locations. One such structure assumes that each funeral home or location is unique, and will have completely separate profile information, including a unique look and feel and offerings catalog. Another such structure assumes that all funeral homes or locations for a particular company is the same, and will have the same look and feel and offerings catalog as every other funeral home owned by the same company. A third such structure is a group-based organization, where only some of the funeral homes owned by a funeral home company need to be treated the same. Selection of these three primary organizational structures is made in web page 140 by selecting one of radio buttons 142, 144 and 146, or using other suitable user input controls as is well known in the art.

To support the third category of organizational structure, server 12 incorporates the concept of “groups”, whereby individual funeral homes are assigned to particular groups for the purpose of sharing certain types of profile information with other members of the same group. In this regard, two types of groups are supported, and may be enabled by a user via selection of check boxes 148 and 150, which are enabled whenever radio button 146 has been selected by a user.

The first is a “branding” group, which groups together funeral homes that require the same look and feel or appearance. It is conceivable, for example, that a given funeral home company may acquire different family-owned funeral homes, yet desire to maintain the original names of those funeral homes, complete with original color schemes, logos, etc. If a funeral home company acquired a chain of family-owned funeral homes, all of the homes in that chain could be assigned the same branding group to ensure that the look and feel of the web sites for those funeral homes would remain the same.

The second is a “catalog” group, which enables a funeral home company to specify different product and service offerings, as well as price lists, to be assigned to a collection of funeral homes in a particular group. As such, it is conceivable that a funeral home company could maintain separate offerings tailored to certain geographic regions, or could even tailor offerings to different classes of customers, e.g., premium vs. discount offerings.

As should be apparent from the above, web page 140 is configured for use only with funeral home companies that have multiple funeral homes, indicating that in some instances, it may be desirable to distinguish between individually-owned funeral homes and funeral home companies that own multiple funeral homes. In other embodiments, however, individually-owned funeral homes may simply be treated the same as funeral home companies where all funeral homes owned by that company share the same branding and product catalogs. Various alternative configurations of web page 140 to support single funeral homes may be envisioned, e.g., via the inclusion of a “single location” radio button, or via selective disabling of one or more of controls 142, 144, 146, 148 and 150.

Returning to FIG. 5, link 128 is therefore displayed only when appropriate for a particular funeral home company. In addition, one or more assign locations links 130 and one or more group editing links 132, are displayed whenever branding and/or catalog groups are enabled. Location assignment is used to assign specific funeral homes to various groups, and group editing is used to create, edit and remove groups, as will become more apparent below.

Reconfigurable Administration Interface

As discussed above, server 12 is configured to provide a varying user interface based upon the company structure selected for a particular funeral home company. Examples of different user interfaces that may be displayed as alternative administration pages are illustrated in FIGS. 7-10.

FIG. 7, for example, shows an administration page 104A utilized for an individual funeral home, or a funeral home company with only one location. In this regard, links 106-126 are broken into two subsections 160, 162. Subsection 160 is entitled “user administration”, and includes links 106, 108, 110 and 112 to support administration of the authorized users on an account. Subsection 162 is entitled “funeral home company”, and includes links 114, 116, 118, 120, 122, 124 and 126 to manage the profile information for the funeral home company as a single profile.

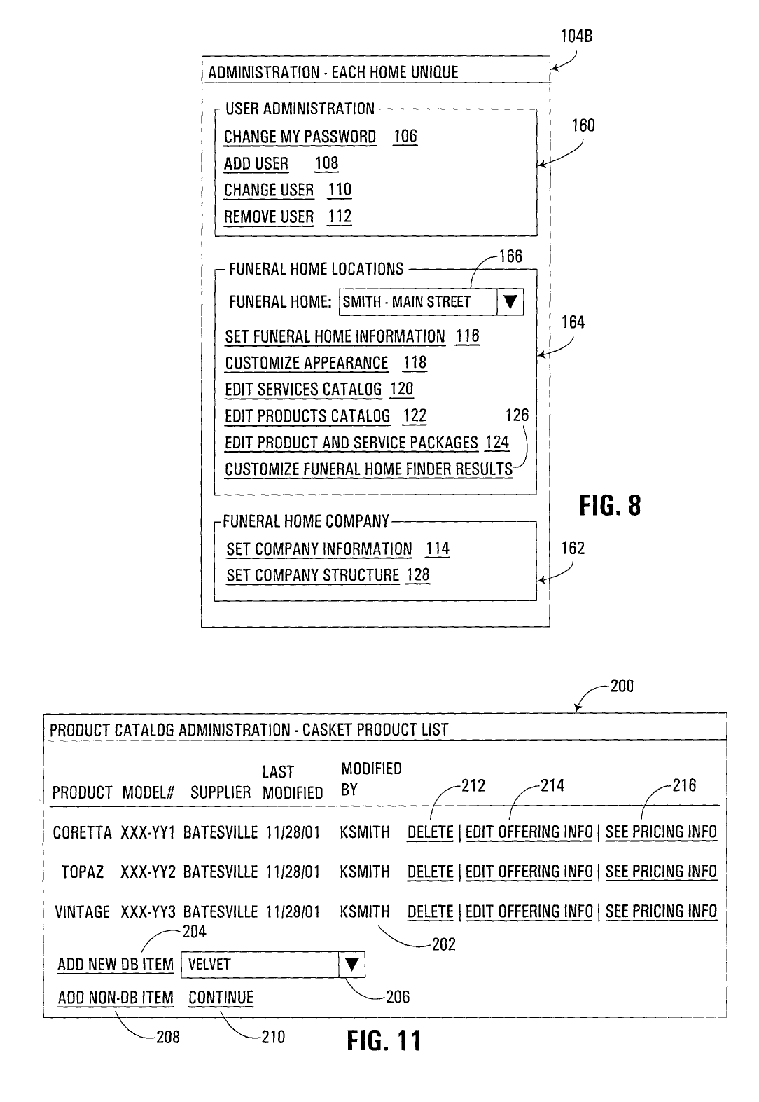

FIG. 8, in contrast, shows an administration page 104B utilized for a multi-location funeral home company where all funeral homes are treated separately, and individually customized for look and feel and for catalog offerings. A user administration subsection 160 includes the same links 106, 108, 110 and 112; however, the funeral home company subsection 162 includes only link 114, and a set company structure link 128 (which opens web page 140 of FIG. 6). A new subsection 164, entitled “funeral home locations” is used to set unique profile information for each funeral home. A drop down menu 166 is used to select from among the various funeral home locations for an account, and links 116, 118, 120, 122, 124 and 126 are positioned in subsection 164 to permit such profile information to be configured for the currently-selected funeral home displayed in menu 166. A user thus configures the profile information for a specific funeral home by selecting a funeral home in menu 166, then selecting the appropriate links 116-126 to configure the profile information for that funeral home.

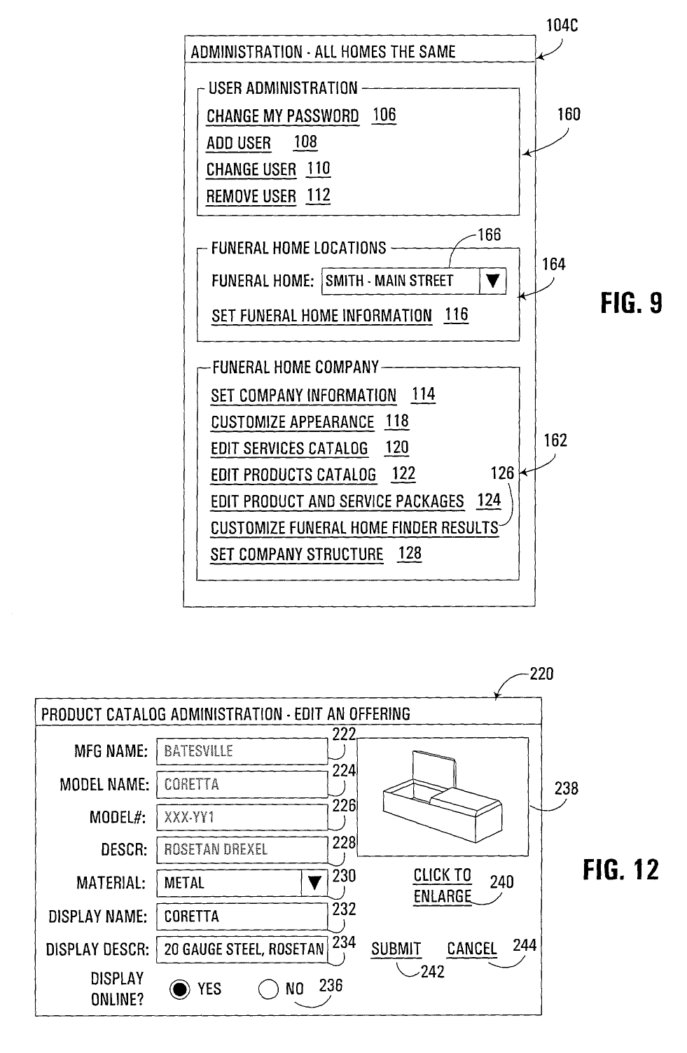

FIG. 9 next shows an administration page 104C utilized for a multi-location funeral home company where all funeral homes are treated the same, and share the same look and feel and catalog offerings. A user administration subsection 160 includes the same links 106, 108, 110 and 112; however, in contrast to administration page 104B, the funeral home company subsection 162 includes, in addition to links 114 and 128, links 118, 120, 122, 124 and 126. The funeral home locations subsection 164 includes only drop down menu 166 and link 116, the latter of which is used to set funeral home information such as addresses, telephone numbers, etc., rather than any look and feel or catalog offerings information. A user thus configures the profile information for all of the funeral home company locations through interaction with links 114 and 118-128 in subsection 162.

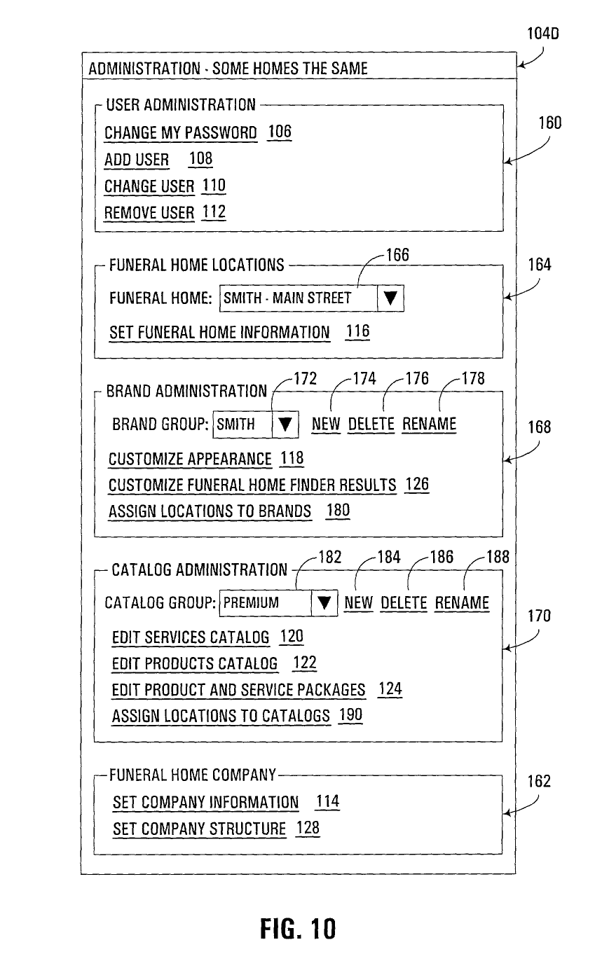

FIG. 10 next shows an administration page 104D utilized for a multi-location funeral home company where groups have been established. Two additional subsections 168 and 170 are utilized to handle group-specific functions for branding and catalog groups, respectively. Should only one type of group be selected by a user, only the appropriate subsection 168 or 170 would be displayed.

As with the other administration pages, a user administration subsection 160 includes the same links 106, 108, 110 and 112. In addition, as with administration page 104B, the funeral home company subsection 162 includes only links 114 and 128. The funeral home locations subsection 164 includes only drop down menu 166 and link 116. Selection of look and feel, and of catalog offerings, is supported by subsections 168 and 170, respectively.

In connection with look and feel, link 118 and link 126 are placed in subsection 168. In addition, a drop down menu 172 is used to select a brand group to be managed via links 118 and 126. Brand groups may be added, removed and renamed via selection of links 174, 176 and 178, respectively. Once a brand group has been created, funeral home locations are assigned to different brand groups via selection of link 180.

Likewise, in connection with catalog offerings, links 120, 122 and 124 are placed in subsection 170. In addition, a drop down menu 182 is used to select a catalog group to be managed via links 120, 122 and 124. Catalog groups may be added, removed and renamed via selection of links 184, 186 and 188, respectively. Once a catalog group has been created, the various funeral home locations are assigned to different catalog groups via selection of link 190.

It will be appreciated that, if only one type of group is used, the links associated with an unused group type would be disposed in the same subsections as shown for either of administration pages 104B or 104C, depending upon whether the default in the absence of a group was to treat all funeral homes separately or the same. For example, if it is determined that in the absence of a group, all funeral homes will be treated the same, in the instance where no brand groups were used, links 118 and 126 would be moved to subsection 162. Likewise, in the instance where no catalog groups were used, links 120, 122 and 124 would be moved to subsection 162.

Catalog Creation

FIGS. 11-16 illustrate in greater detail the user interface utilized in connection with administration of a group offering catalog. FIG. 11 in particular illustrates a product list web page 200 displayed subsequent to user selection of an “edit product catalog” link in one of administration pages 104A-104D. As mentioned above, in the illustrated embodiment, an offering catalog may be segregated into separate product and service catalogs, and in this regard, handling of an exemplary product catalog is described in connection with FIGS. 11-13.

One important aspect of the aforementioned catalogs is the ability to integrate products and/or services from both a master item catalog and one or more provider-specific products and/or services into a unique catalog for a funeral home or group of funeral homes. Moreover, pricing of items, whether or not part of the master item catalog, may be custom-tailored for multiple funeral homes or groups of funeral homes. A significant degree of flexibility is therefore provided for managing unique collections of products and services for multiple funeral homes.

In the illustrated embodiment, it is also desirable to segregate products into categories or classes for ease of administration. Web page 200, for example, is utilized to manage the casket offerings of a particular funeral home or group. It is envisioned that a user may be presented with an intermediate web page that enables a user to select from among multiple product categories, e.g., caskets, urns, flowers, memorials, etc. In the alternative, all product offerings may be managed collectively.

As shown in FIG. 11, web page 200 presents a list of selected products 202, displaying brief information about each selected product 202, e.g., model name, model number, supplier, last modified date and last modified by user. In addition, a user is permitted to add new products to a funeral home product catalog, typically either products that are present in the master item catalog, via selection of add new database item link 204 after selecting one of the unselected items from the master item catalog via drop down menu 206, or provider-specific products not present in the master item catalog, via selection of add non-database item link 208. Once management of the product catalog is complete, confirmation of the changes and a return to the administration page may be accomplished via selection of continue link 210.

For selected products in the catalog, a delete link 212, edit offering info link 214 and see pricing info link 216 may be displayed adjacent the listing for such products. Delete link 212 removes a product from a product catalog, and may require confirmation from a user prior to deleting the appropriate record.

Edit offering info link 214 permits a user to modify product information about a product, even if that product is retrieved from the master item catalog. As an example, it may be desirable to modify a product description or name to provide a more customer-friendly depiction to a user. Based upon the database organization discussed above, such modifications may be stored in a group offering record without requiring modification of the offering record for an item resident in the master item catalog.

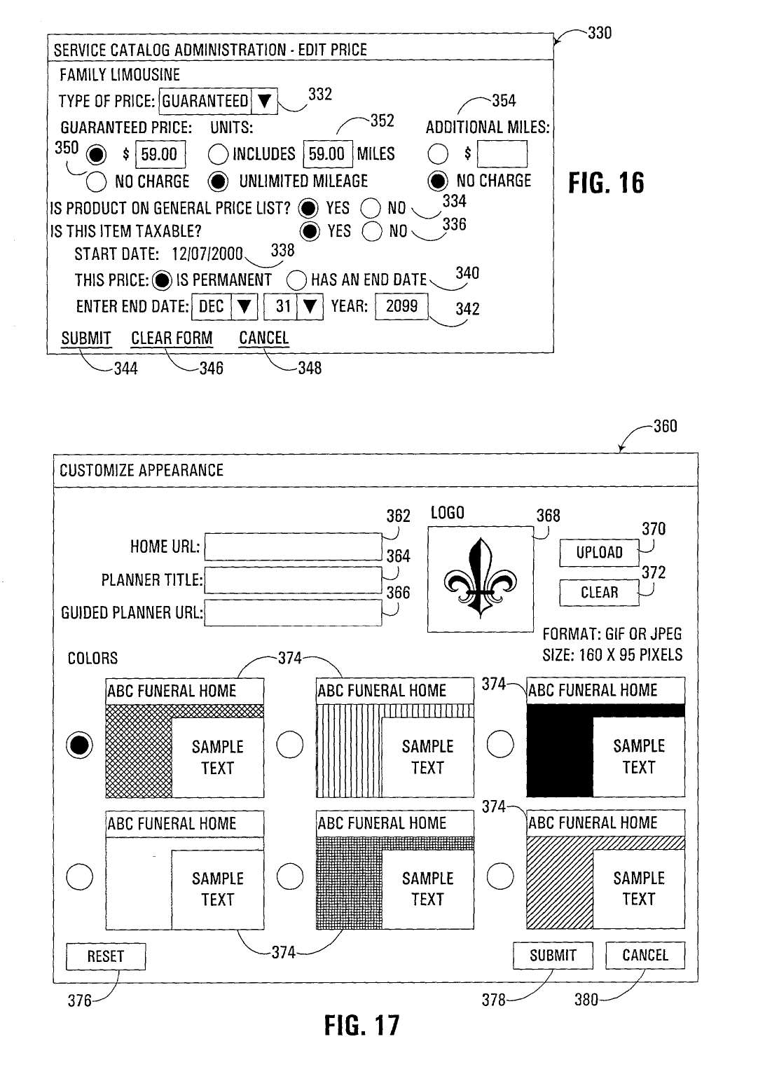

See pricing info link 216 displays current pricing information for a product, and further, permits user modification of pricing for a product. As with the offering information, pricing information may be provider-specific, even for items resident in the master item catalog. Moreover, multiple prices may be associated with a particular product record, e.g., to support seasonal pricing. A discussion of pricing management is provided in greater detail below in connection with FIGS. 15 and 16.

It should be appreciated that construction of web page 200 typically occurs dynamically, generating the list of current selected products for a give group or funeral home catalog, and further dynamically populating menu 206 with appropriate unselected products from the master item catalog. Moreover, whenever a user is required to make a category selection, it should be appreciated that the retrieval of selected and unselected products is limited to only those products that match the particular category with which web page 200 is associated.

FIG. 12 next illustrates an exemplary offering edit web page 220 utilized to edit a product in a group or funeral home catalog, in response to selection of a link 214 on web page 200. Various fields associated with the product are displayed, including manufacturer name 222, model name 224, model number 226, description 228, material 230, display name 232, and display description 234. For products that are originally from the master item catalog, it may be desirable to inhibit editing of certain fields, e.g., as shown for fields 222, 224, 226 and 228 by virtue of the grayed out appearance. Moreover, where only a limited number of selections are possible, e.g., with material field 230, it may be desirable to use a restricted user input control such as a drop down menu to limit the possible choices to a user.

So that the original name and description are maintained in the group offering record, it is desirable to incorporate the separate display name and description fields 232, 234. It is typically the information in these fields that is used to display product information to a customer during selection of products in connection with a funeral plan. By doing so, a funeral home is not tied to the specific name and description in the master item database.

Web page 220 also includes a display online control 236 used to determine whether this product will be separately displayed as a selectable product to a user. The default for this control is “yes”. A “no” value is typically selected when a user wishes to include a product in a package, but not offer that product to a customer outside of the package. When “no” is selected, the product will therefore not be displayed to a customer when selecting individual products.

To further facilitate user selection, it is also desirable to incorporate into each group offering record, one or more graphical images of the associated product, which may be previewed in area 238. Area 238 is used to display a thumbnail-sized image, while selection of link 240 enables a window with a larger image to be displayed to the user. In the illustrated embodiment, when the product being edited is from the master item catalog, the graphical images will be retrieved from the master item catalog, and thus not be modifiable. In other embodiments, however, a user may be permitted to replace a standard image with another image if desired.

Confirmation of modifications, and return to web page 200 is effected by selection of a submit link 242. Canceling without saving changes is accomplished by selecting cancel link 244.

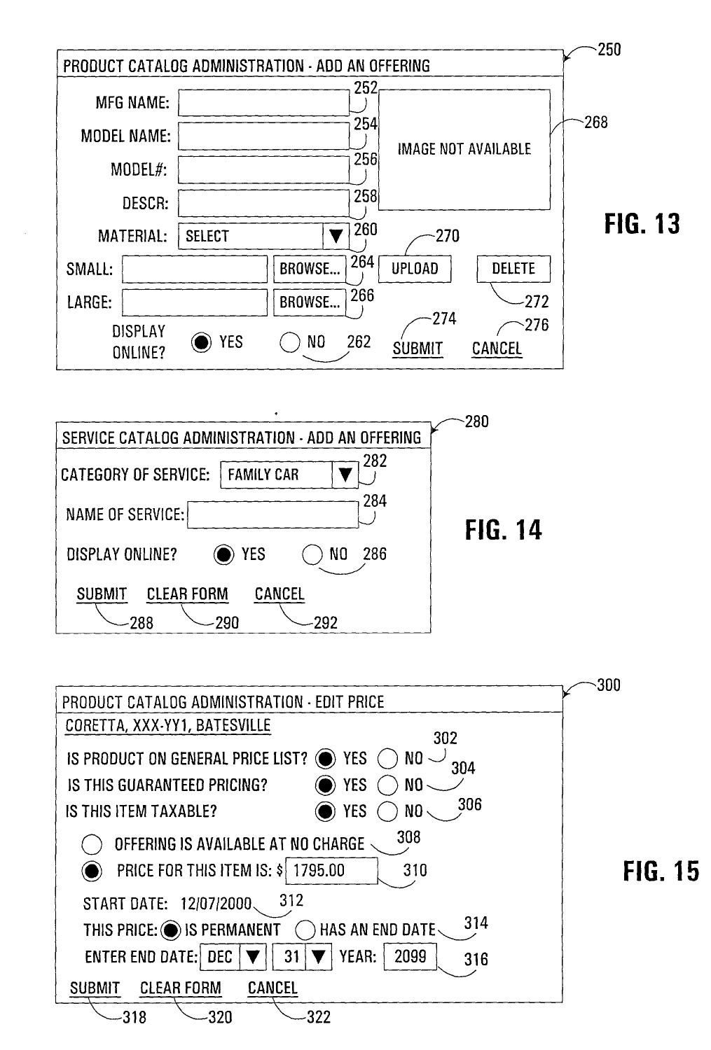

FIG. 13 next illustrates an exemplary add offering web page 250 utilized to add a non-master item catalog offering to a group or funeral home catalog, e.g., in response to selection of link 208 on web page 200. Various fields capable of being input for the product are displayed, including manufacturer name 252, model name 254, model number 256, description 258, and material 260. Given that this record will have no corresponding record in the master item catalog, no separate display name and display description fields are typically required. Also, as with web page 220, web page 250 also includes a display online control 262 used to determine whether this product will be separately displayed as a selectable product to a user, or whether this product will simply be a part of a package.

No image data is typically associated with a new product upon its creation, although a default image may be associated with a new product in some embodiments. A user is permitted to add both large size and thumbnail size graphic images via controls 262 and 264, which permit a user to either input a file and path into an edit box, or open a “browse . . . ” button to display an open file dialog box to search a file system for the appropriate graphics. Once selected, the thumbnail image may be previewed in area 268. Furthermore, once appropriate paths and filenames are input into controls 262, 264, a user is required to select an upload button 270 to upload the image data to server 12, in a manner well known in the art. Existing uploaded files may also be deleted from server 12 via a delete button 272.

Confirmation of modifications, and return to web page 200 is effected by selection of a submit link 274. Canceling without saving changes is accomplished by selecting cancel link 276.

Management of services may occur in much the same manner as products. Furthermore, in other embodiments, services and products may be managed collectively. In the illustrated embodiment, however, services are separately managed, with a web page similar to web page 200 utilized to display lists of selected services and otherwise permit the editing of services, prices for such services, and addition of new services, whether a service from an existing master item database or a provider-specific service. In addition, services may be categorized by category or class in some embodiments.

FIG. 14 illustrates by way of example an add offering web page 280 for use in adding a new service to a services catalog. Via a drop down menu 282, a user is permitted to select a service category (e.g., transportation, preparation, entombment, etc.). The name of the service is entered into an edit box 284, and similar to the aforementioned products catalogs, a display online control 286 determines whether the service will be separately displayed. A submit link 288 confirms changes and returns to a service list page, while a clear form link 290 clears the fields in web page 280, and cancel link 292 closes web page 280 without altering the services catalog.

Next, FIGS. 15 and 16 respectively illustrate web pages 300 and 330, used to edit pricing information for a product and a service in the respective product and services catalogs for a group or funeral home. As discussed above, multiple prices may be associated with any given item, and as such, creation of a price results in the addition of a new group offering price record to the group offering price table. In the illustrated embodiment, an intermediate price list web page, similar in many respects to web page 200, may be used to display selected prices for an item, and to permit a user to edit a price or add a new price. In such an instance, web pages 300 and 330 would be displayed in response to user activation of appropriate links on a price list web page.

Web page 300 is an exemplary user interface for generating a new price, or editing an existing price, for a product. In this regard, several flags may be set using controls 302, 304 and 306 to set whether the price is on a general price list, whether the price is guaranteed, and whether the item is taxable. Controls 308 and 310 determine whether the offering is available at no charge, or at a specified charge input by the user. Control 312 displays the start date for the price, while control 314 determines whether the price is permanent or has an end date. If an end date is associated with the price, control 316 is used to input that end date. A submit link 318 confirms changes and returns to a price list page, while a clear form link 320 clears the fields in web page 300, and cancel link 322 closes web page 300 without altering the price list.

Web page 330 is an exemplary user interface for generating a new price, or editing an existing price, for a service. Furthermore web page 330 illustrates the manner in which a standardized web page can be modified to request additional detail specific to a particular product or service. In this example web page, a price for a limousine is being specified, and unlike many items that might have a fixed charge, the cost for the limousine may be based upon variable factors such as mileage and some flat rate.

Web page 330 includes controls 334, 336, 338, 340, 342, 344, 346 and 348, which operate in a similar manner to controls 302, 306, 312, 314, 316, 318, 320 and 322 of web page 300. However, to accommodate a variable pricing scheme, web page 330 includes a price type control 332, a base price control 350 (which enables input of no charge or a fixed fee), a units control 352 (which enables input of an included number of miles, or unlimited miles), and an additional miles control 354 (which enables input of an additional per mile charge, or no additional charge).

It should be appreciated that price edit web pages may be tailored to suit any number of different pricing schemes, and thus web pages 300 and 330 are merely exemplary in nature. Moreover, it will be appreciated that a wide variety of alternate user input controls and pages may be used to administer and manage product and services catalogs consistent with the invention.

Branding

As discussed above, the look and feel of a funeral planner web site can be custom-tailored for a particular funeral home or group of funeral homes. Typically, this is performed via storing custom style sheets (or references thereto) and customized logos in group-specific directories in server 12.

Web page 360 of FIG. 17 illustrates one manner in which a user may select the custom look and feel of a provider-specific funeral planner web site. Web page 360 is typically called in response to selection of a customize appearance link 118 on an administration page 104A-104D. Specifically, it may be desirable to retrieve information such as a home URL for the funeral home web site and a title to be displayed on the title bar of a browser, via input boxes 362 and 364. In a guided planner URL box 368, it is envisioned that the URL that a user needs to insert on the funeral home web site to reference the guided planner (including funeral home ID and brand group ID references in the URL) is displayed to a user.

Area 368 displays the current logo for the funeral home, and controls 370 and 372 permit a user to either upload a new logo to the server or delete the current logo from the server. Radio buttons 374 permit a user to select from a plurality of color schemes, with representative graphics of the color schemes displayed in association with each radio button 374. A user may be provided with varied color schemes such as blue and white, pink and purple, red and blue, etc. Moreover, given that the color schemes are represented in style sheets, other stylistic information, e.g., fonts, layouts, graphics, etc., may also be selected in connection with one of radio buttons 374. In the alternative, the various stylistic options may be separately configurable by a user.

Reset button 376 resets the form, while submit button 378 stores the changes and cancel button 380 closes the web page without saving changes.

Alternate manners of customizing the look and feel of a web site may be utilized in connection with the funeral home branding concepts discussed herein. Therefore, the invention is not limited to the specific embodiments discussed herein.

Group Management

As discussed above in connection with the variable administration page configuration, funeral homes may be assigned to branding and/or catalog groups to facilitate the collective management of related funeral homes.

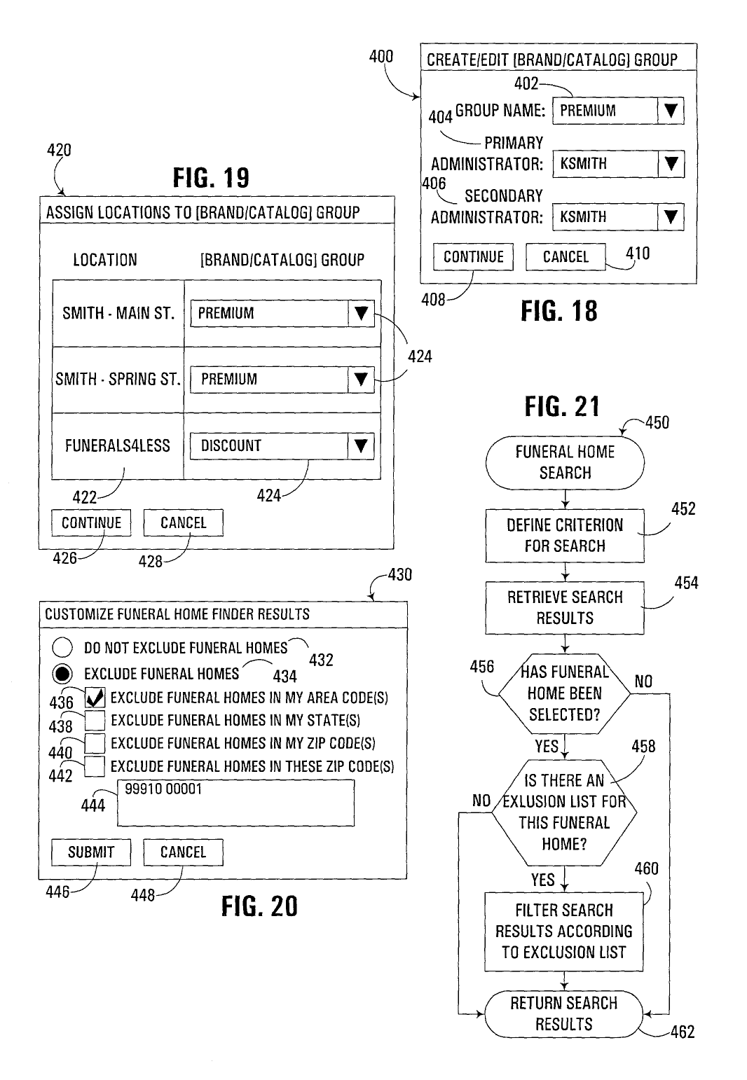

Returning briefly to FIG. 10, links 174 and 184 of administration page 104D refer to the creation of a new branding or catalog group. While various manners of creating a group may be envisioned, one manner is to display a web page such as web page 400 of FIG. 18. Web page 400 may also be used to edit an existing group, if desired.

Web page 400 includes a menu control 402 to select a group name from an list of possible group names. A user may also enter a new group name in menu 402. In association with the creation of a new group, a primary, and optionally, a secondary administrator, may also be selected from drop down menus 404 and 406. Assignment of group administrators limits the number of users who can modify a group. Continue button 408 saves the changes, while cancel button 410 closes the web page without saving changes.

Once groups have been established, funeral homes, or locations, can be assigned to particular groups. FIG. 19 illustrates an exemplary web page 420 suitable for assigning locations to brand and/or catalog groups. Web page 420 as shown displays a list of locations 422, coupled with matching drop down menus 424 from which groups to be assigned to the locations are selected. Continue button 426 saves the changes, while cancel button 428 closes the web page without saving changes.

In the illustrated embodiment, both brand groups and catalog groups are uniquely identified by a group ID number. Depending upon whether the server needs to access brand information or catalog information in connection with generating a funeral plan web page, either the brand or catalog group ID number is accessed as appropriate. In other embodiments, combined brand/catalog groups may be defined, if desired.

Funeral Home Finder

FIG. 20 illustrates an exemplary customize funeral home finder results web page 430 used to generate the search exclusion data for a funeral home or group. The ability to exclude certain competitors within a given geographical area often makes the multi-provider funeral planner web site more attractive to funeral homes, as there is a reduced risk that a customer, originally entering a funeral plan web site from a particular funeral home's web site, will be directed to a competitor's web site during a later funeral home search conducted through the customized funeral plan web site for that funeral home.

Geographic exclusion information may be based upon any number of factors, including distance, area code, ZIP code, state, city, etc. Web page 430, for example, is displayed in response to user selection of a link 126 on an administration page 104A-104D, and includes radio buttons 434 used to select whether or not search exclusion is to be enabled. If radio button 434 is selected, a user is then permitted to set one or more exclusion criterion, e.g., based upon the same area code (check box 436), based upon the same state (check box 438), based upon the same ZIP code (check box 440), or based upon a specific area code (check box 442, and entered into edit box 444). A submit button 446 is used to create a new search exclusion record in table 88, while a cancel button 448 closes web page 430 without making any changes. Other exclusion criterion, based upon other geographic criterion, or even on non-geographic criterion, may also be used in the alternative.

The result of the creation of a search exclusion criterion is that search results will be filtered prior to presentation to a customer whenever that customer attempts to perform a funeral home search while contacting the funeral planner web site indirectly from a funeral home web site. FIG. 21, for example, illustrates an exemplary funeral home search routine 450, executed by the funeral planner program code when interacting with a user. As discussed in the aforementioned co-pending application entitled “System and Method of Planning a Funeral,” one manner of performing a funeral home search is described. Routine 450 builds upon this search methodology to include selective filtering of results. Specifically, routine 450 begins in block 452 by defining the criterion for the search, e.g., a geographic position and radius, or any other form of location searching parameter known in the art. Next, in block 454, search results matching the criterion are retrieved. However, prior to returning these results to the customer, control passes to blocks 456 and 458 to determine whether a funeral home has already been selected (or alternately, only that a customer entered the funeral planner web site via a particular funeral home's web site), and if so, whether an exclusion list exists for this funeral home. If both conditions are true, control passes to block 460 to filter the search results according to the exclusion list. Control then passes to block 462 to return the filtered search results. If on the other hand either of the conditions in blocks 456 and 458 has not been met, block 460 is bypassed, and the search results generated in block 454 are returned in block 462 without any filtering.

Packages

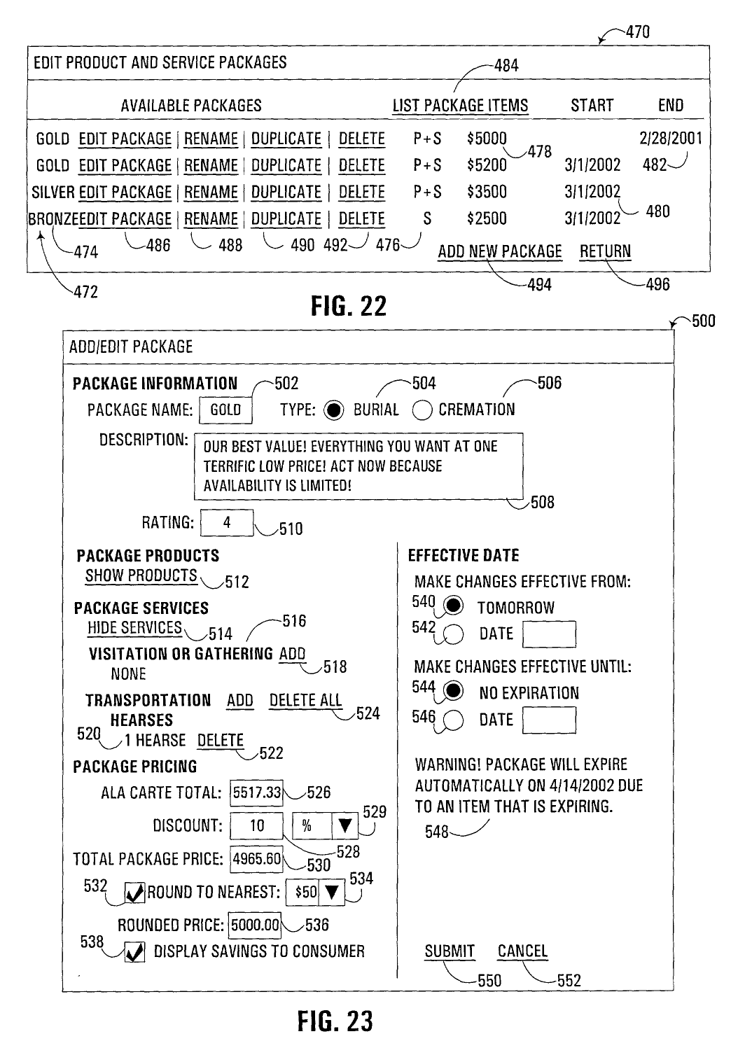

FIGS. 22-25 illustrate a number of administration web pages associated with creating and managing packages of products and/or services. As discussed above, a package may be associated with a list of products and/or services from the item catalogs for a particular funeral home or group. In addition, a package description, type, and rating may be associated with a package, as may starting and end dates for the package.

FIG. 22 illustrates an edit packages web page 470, which is displayed, for example, in response to selection of a link 124 from an administration page 104A-D. Web page 470 is dynamically generated to display a list of existing packages 472, each displaying various information such as package name 474, an indication 476 of whether the package includes products, services, or both, a package price 478, a start date 480 and an end date 482. The representation of FIG. 22 displays a condensed view, where the items in each package are hidden. It may therefore be desirable to permit an expanded view to be displayed, e.g., in response to selection of a link 484.

In addition, various editing options may be supported for existing packages. A package may be edited via selection of a link 486, while a package may be renamed through selection of a link 488. To save the effort in creating a new package from scratch, it may also be desirable to permit a user to duplicate an existing package through selection of a link 490. Moreover, a user may delete a package via selection of a link 492. It should be appreciated that confirmation pages may also be generated to confirm any editing operations prior to applying those operations to an existing package.

A user may also add packages for a funeral home or group through selection of a link 494. Once a user is finished with editing the package list for a funeral home or group, the user may return to the administration page via a link 496.

As mentioned above, whenever a new package is created, a record is added to the group offering table 82. Then, as items are added to the package, records are added to the package item table 86, with appropriate references to the package group offering record, the group offering record of the added item, and the catalog group ID for the package. In addition, a group offering price record is typically added to table 84 to store a price for the package.

FIG. 23 next illustrates an add/edit package web page 500, which may be displayed, for example, after selecting either an edit package link 486 for an existing package, or the add new package link 494 for a new package, in web page 470. The information associated with a package is typically categorized into one of package information, package products, package services, package pricing, and effective date.

For the package information, a package name is input and displayed in box 502. Moreover, a package is typically associated with a type of either “burial” or “cremation”, controlled via selection of one of radio buttons 504 and 506. Given the typical differences between a burial-type funeral and a cremation-type funeral, it may be desirable to modify the categories or classes of products and services made available for a package. As an example, it may be desirable to not display a “casket” product type when a cremation type is selected for the package. In other embodiments, however, no package type may be used.

The package information also includes a description, displayed and input in box 508, and a rating 510, used by a user to identify a relative rating for the package. A graphical image may also be displayed in connection with a rating.

Package products and services are also selectively displayed. In some instances, it may be desirable to condense a portion of web page 500 initially, to facilitate user interaction with the page. In this regard, web page 500 illustrates a “package products” heading with no selected products shown. Instead, a show products link 512 is included to permit a user to select the link and have web page 500 redisplayed with a list of products for the package, as well as to enable a user to add new products or edit products already added to a package.

Web page 500 also displays the selected services for a package, and as with the package products, the services may be selectively displayed. Link 514, for example, may be selected by a user to redisplay web page 500 with services hidden.

When services are displayed, as shown in FIG. 23, the services are typically categorized by categories or classes, as represented by headings 516. Moreover, multiple levels of organization may be used (see, e.g., “hearses” under the “transportation” heading). FIG. 23 shows only “visitation or gathering” and “transportation” service categories; however, it will be appreciated that typically a larger number of categories may also be defined and displayed, e.g., “funeral or memorial service”, “cemetery or scattering services”, “arrangement and embalming”, “other services”, “flowers”, etc.

A user is permitted to add a new item for a particular category by selecting an add link 518 displayed adjacent a category heading. Once added, an entry 520 is displayed for a selected service, including a service name, and optionally, a quantity. A user is permitted to delete a service or even all services under a category by selecting a link 522 or 524. Moreover, where multiple items may be selected under a particular category, a default item may be displayed, and an appropriate link to set an item to be a default may be used as well (not shown).

An additional important aspect of a package is that of a price. Other than the convenience of selecting a single package instead of selecting individual items one by one, the attractiveness of a package to a customer may be due to the provision of a discount for the package from the ala carte pricing of the products and services selected for that package. In this regard, the package pricing section of page 500 includes a box 526 that displays the calculated price of the package based upon the individual costs for the items selected in the package. Selection of a package price, however, may be made based upon one or more of selecting a discount and a rounding rule.

A discount may be selected, for example, by entering a value in a box 528, and a discount type in menu 529. The discount type may be, for example, a fixed discount, or a percentage discount. For example, FIG. 23 illustrates the selection of a 10% discount. Once the discount is applied, the discounted package price is displayed in box 530. A rounding rule may be selected based upon selection of checkbox 532 and selection of a round value in menu 534. The rounded price is then displayed in box 536. In other embodiments, a user may simply input a package price directly.

In addition, it may be desirable to display the discount to the customer to provide a further incentive to a customer that may not be cognizant of the ala carte price of a package. Selection of this display option may be made via a checkbox 538.

As with individual items, a package may also be associated with start and end dates. Controls 540 and 542 select a start date of either tomorrow or a fixed date input by the user. Likewise, controls 544 and 546 select an end date of either “no expiration” or a fixed date input by the user. Moreover, it may be desirable to display messages in area 548. For example, it may be desirable to analyze the products and services for a package to determine whether any prices for those products and services is set to expire. If so, it may be desirable to display to the user a warning that the package will also expire as of the date that a price of a selected product or service expires.

Submission of package changes is effected through selection of submit link 550. Cancellation of a package edit or create is effected through selection of cancel link 552.

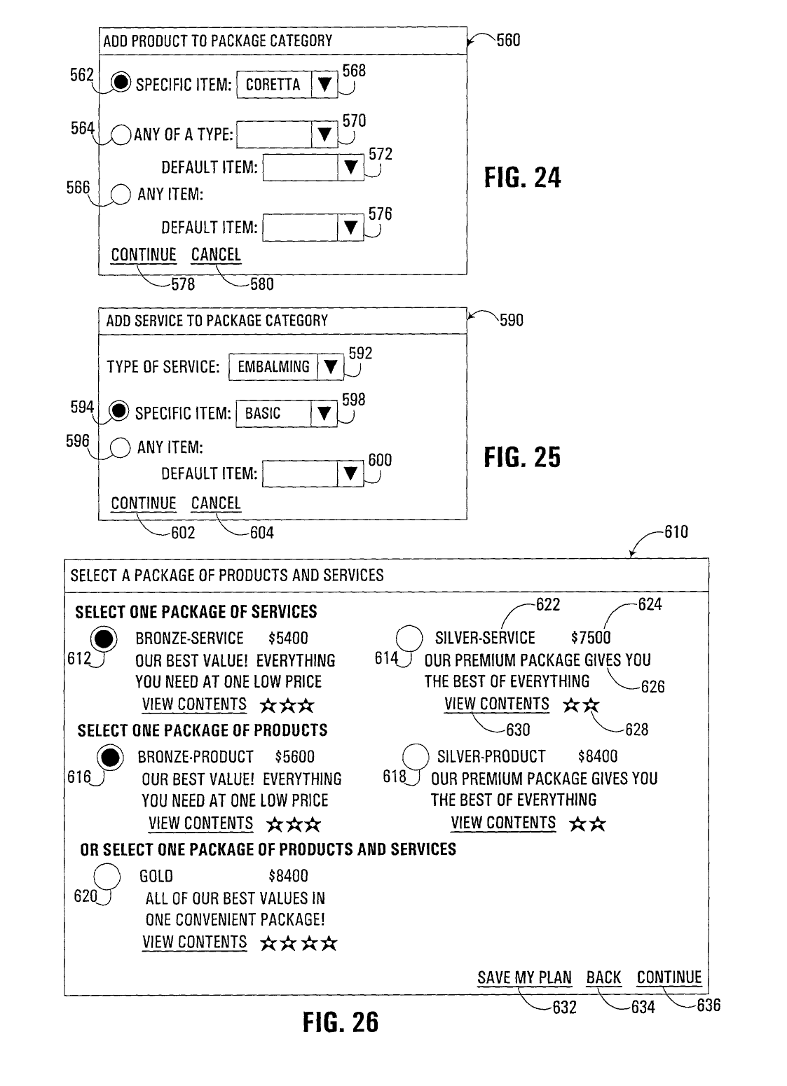

FIGS. 24 and 25 next illustrate add product and add service web pages 560, 590 used to add products or services of a particular category to a package. For a product, web page 560 permits, via selection of one of radio buttons 562, 564 and 566, either a specific item in a category, a type of item within a particular category, or any item within a category. When button 562 is selected, the particular item is selected in a menu 568, populated with all items from the product catalog of that particular category. When button 564 is selected, an item type is selected in a menu 570 populated with different types for the category (e.g., for a “casket” category, the types might be “hardware”, “metal”, etc.). In addition, it may be desirable to specify a default item from menu 572, which may be supplied as the selected item when no specific item is specified by a customer during funeral planning. When button 566 is selected, any item from a category is available to the customer for selection, and only a default item need be selected in menu 576. Continue link 578 saves the changes, while cancel link 580 closes the web page without saving changes.

For a service, web page 590 permits, a user to first select a type of service via a drop down menu 592. A user is also able to select either a specific item or any item via radio buttons 594 and 596. If a specific item is desired, the user selects an item via drop down menu 598, which is populated with all services matching the selected type. If any item is selected, a default item is selected via menu 600. Continue link 602 saves the changes, while cancel link 604 closes the web page without saving changes.

In general, any of a number of item classifications, including classes, categories, types, etc., may be used to distinguish items in packages and catalogs. Moreover, a package may generically identify any of such item classifications, as well as an optional default item matching such a classification, in lieu of identifying a specific item for inclusion in a package. By doing so, a customer eventually selecting or purchasing the package is permitted, for that package price, to select and obtain from multiple items matching a selected item classification. It will be appreciated that an item from a selected item classification may be selected during creation of the funeral plan and selection of the package, or in the alternative, at a later date, e.g., when the funeral plan is being carried out upon the death of the subject of that plan.

A package may be selected by a customer in connection with developing a funeral plan, as described in the aforementioned U.S. patent application entitled “System and Method of Planning a Funeral.” As shown in FIG. 26, for example, during the funeral planning process, a web page 610 may be displayed to a user to select a package in lieu of, or in addition to, selection of individual products and services. As shown in web page 610, all available packages may be displayed, and moreover, such packages may be separated based upon whether such packages are product-only packages, service-only packages, or packages with combined products and services. In the exemplary web page 610, it is assumed that a particular funeral home or group has two product only packages, two service only packages, and one combined products and services package. In this regard, a customer may be able to select one product package and one service package, via selection of one of radio buttons 612 and 614, and one of radio buttons 616 and 618, or the customer may select the combined product and services package via radio button 620. Where other numbers of packages are available, various alternate selection mechanisms may be used.

Displayed for each package may be a package name 622, package price 624, package description 626 and package rating 628. In addition, to conserve space, it may be desirable to initially hide the contents of a package and provide a mechanism whereby a customer may click on a link such as link 630 to open another web page with a list of the included products and/or services. Standard funeral planning links, including a save my plan link 632, a back link 634 and a continue link 636 are also typically provided in web page 610. Once selected, a package is typically associated with a customer's funeral plan. Based upon the capabilities of the funeral planner, a customer would then be able to store the funeral plan, purchase the funeral plan, finance the funeral plan, or perform other actions described in the aforementioned U.S. patent application.

It will be appreciated that, in general, construction of an appropriate set of web pages to implement the herein-described administration functionality, as well as the configuration, implementation, setup and access to the herein-described database, would be well within the ability of one of ordinary skill in the art having the benefit of the instant disclosure. Moreover, it will be appreciated that other user interface mechanisms, including other types and combinations of user input controls, as well as non-web based interfaces, may be used in the alternative. Therefore, the invention is not limited to the particular implementations discussed herein.

### Funeral Plan Web Page Generation

The generation of web pages during development of a funeral plan by a customer is tailored to a specific look and feel. Whether that look and feel is standard, or customized for a particular funeral home or group, is dependent upon whether a brand group ID and funeral home ID are provided in the URL used to access the funeral planner web site. For a standard look and feel, when no funeral home and/or brand group ID is supplied to the funeral planner program code, standard style sheets and logos may be used. However, the look and feel selected by a particular funeral home or group may be applied to the standard web pages generated during a funeral planning episode with a customer responsive to provision of a valid brand group ID and/or funeral home ID.

To generate the custom look and feel, the brand group ID is used to determine if an associated directory exists on server 12, and if such a directory does exist, a style sheet, logo, title and any other desired customization information is retrieved from that directory. Otherwise, standard style sheets and the like are used. It will be appreciated that other manners of defining unique looks and feel, including for example, inclusion of individual customized web page templates for each step in a funeral plan in each provider-specific directory, may also be used in the alternative.

Likewise, whenever products, services or packages are to be presented to a customer for display and/or selection, the catalog group ID and/or funeral home ID is used by the funeral planner program code to determine what products, services and packages are to be dynamically populated into the appropriate funeral planning web pages. If no specialized catalogs or packages exist for a particular funeral home selected by a user, then the master item catalog may be used, or in the alternative, selection of products, services and/or packages may not be permitted for a customer.

In addition, in some embodiments, it may be desirable to also incorporate into server 12 the capability to enable and facilitate compliance with various state specific requirements and disclosures such as display of state license number, display of name of licensed agent, display of name of manager of funeral firm, display of true funeral home name as registered with Board of Mortuary Science, etc. Flexibility is desired in the administration of these requirements in such embodiments as the funeral and insurance industries are typically regulated at the state level. One state's requirements therefore are not necessarily applicable to funeral homes or insurance agents in another state.

To this extent, it may be desirable to incorporate functionality to incorporate, when necessary, appropriate disclosures and text into the funeral plan web pages generated during a funeral planning session. Such disclosures and text may be keyed off of the state stored for the selected funeral home, and added dynamically as needed. In addition, other state-specific information, which may not necessarily be required to comply with disclosure requirements, may be provided to customers in connection with a funeral plan, e.g., for educational purposes.

Moreover, it may be desirable to incorporate additional functionality into the administration web pages to ensure that all necessary information, such as contact persons, license numbers, funeral home names, telephone numbers, etc., is entered so that the disclosures to a customer during creation of a funeral plan will be complete. The administration functionality may also provide information to authorized users advising them of the applicable requirements.

Other forms of error checking, whether from the customer side in the funeral planner or on the administration side, may also be incorporated into server 12. It will be appreciated that the configuration of a web server to generate the applicable requirements and disclosures based upon the state of residence of a funeral home, as well as other forms of error checking, would be well within the abilities of one of ordinary skill in the art having the benefit of the instant disclosure.

It will be appreciated that other manners of customizing a web site based upon provider profile information may be used consistent with the invention. Moreover, it will be appreciated that the construction of customized web pages using the provider profile information discussed herein would be well within the abilities of one of ordinary skill in the art having the benefit of the instant disclosure.

### Alternative Embodiments

Various modifications may be made to the illustrated embodiments without departing from the spirit and scope of the invention. For example, it may be desirable to incorporate additional administration and/or funeral planner functionality. As one example, it may be desirable to provide support for premiums, in which customers are given free items such as information guides, books, and planning guides, or discounts on products and/or services, if they choose to register with the funeral planner web site. In such instances, an email address may be associated with a funeral home to receive an automatic notification whenever a customer registers with the funeral planner web site, so that the premium can be fulfilled in due course.

In addition, it may be desirable to incorporate the same functionality on behalf of other funerary service providers such as cemeteries. In addition, other manners of interfacing with a customer may be used in the alternative. For example, the aforementioned functionality may be implemented in a local, hard coded medium, such as via a CD-ROM and hard drive install on a desktop or laptop computer, to be used in a one-to-one conference with a family either at a funeral home or at a family home. As another example, all or a portion of the herein-described program code and database information may be downloaded to a customer's local computer, with database synchronization used to keep the local program code and/or database information in synchronization with pricing and other profile information. As another example, such local program code may be distributed with a CD-ROM that may be direct mailed to a customer, with synchronization, or remote access, to profile and other information being made available over the Internet.

Other modifications will be apparent to one of ordinary skill in the art. Therefore, the invention lies in the claims hereinafter appended.

What is claimed is:

1. An apparatus, comprising:
(a) a database storing item information regarding a plurality of funerary items;
(b) a plurality of provider profile data structures respectively configured to define at least one provider catalog for each of a plurality of funerary service providers, each provider profile data structure identifying a subset of the plurality of funerary items from the database to be included in the provider catalog defined thereby, each provider profile data structure further identifying provider-specific pricing information for at least a subset of the funerary items identified in the provider catalog defined thereby; and
(c) program code configured to access the provider catalog for each funerary service provider by accessing the provider profile data structure associated with such funerary service provider.

2. The apparatus of claim 1, wherein at least one provider profile data structure further identifies for the provider catalog defined thereby at least one additional provider-specific funerary item that is not stored in the database.

3. The apparatus of claim 1, wherein the program code comprises funeral planner program code configured to interact with a customer to create a funeral plan for that customer, the funeral planner program code configured to access the provider catalog for a first funerary service provider to display a portion of the provider catalog to the customer after selection of the first funerary service provider by the customer.

4. The apparatus of claim 3, wherein selection of the first funerary service provider is made by the customer in response to a search of funerary service providers.

5. The apparatus of claim 3, wherein selection of the first funerary service provider is made by the customer in response to contacting a funeral plan web site via a link from a web site for the first funerary service provider.

6. The apparatus of claim 3, wherein the program code comprises administration program code configured to modify the provider profile data structure for a first funerary service provider in response to user input from an authorized user for the first funerary service provider.

7. The apparatus of claim 1, wherein the provider profile data structure for a first funerary service provider includes an offering data structure that identifies an item stored in the database, the offering data structure further including provider-specific name and description fields to be displayed in lieu of name and description information stored in the database for the item.

8. The apparatus of claim 1, wherein the provider-specific pricing information identified in the provider profile data structure for a first funerary service provider is associated with at least one of a start date and an end date.

9. The apparatus of claim 1, wherein the provider profile data structure for a first funerary service provider further identifies at least one package, the package identifying a subset of items from the provider catalog defined by the provider profile data structure, and a package price for the subset of items from the provider catalog.

10. The apparatus of claim 9, wherein the provider profile data structure for the first funerary service provider identifies a plurality of packages, and wherein the program code is further configured to access the provider profile data structure for the first funerary service provider during creation of a funeral plan for a customer, and generate therefrom a list of packages for selection by the customer for incorporation into the funeral plan.

11. The apparatus of claim 9, wherein the program code is further configured to access the provider profile data structure for the first funerary service provider when creating or modifying the package in response to user input from an authorized user for the first funerary service provider.

12. The apparatus of claim 9, wherein at least one item from the subset of items identified by the package is identified in the provider profile data structure for the first funerary service provider as being displayable only in connection with the package such that the item is not separately selectable by a customer when viewing the provider catalog for the first funerary service provider.

13. The apparatus of claim 9, wherein the provider profile data structure for the first funerary service provider further identifies a discount from which the package price is derived from the provider-specific pricing information for the subset of items identified for the package.

14. The apparatus of claim 9, wherein the package identifies at least one item classification such that a customer is permitted to obtain any of a plurality of items matching the item classification for inclusion in the package.

15. The apparatus of claim 14, wherein the package further identifies at least one default item for the item classification.

16. The apparatus of claim 1, wherein at least one provider catalog identifies a funerary product and a funerary service.

17. The apparatus of claim 1, wherein the provider profile data structure for a first funerary service provider identifies first and second provider catalogs, the first and second provider catalogs respectively associated with first and second groups, the first and second provider catalogs differing from one another based upon at least one of the subsets of items and provider-specific pricing information identified thereby.

18. The apparatus of claim 17, wherein the provider profile data structure for the first funerary service provider further identifies first and second locations, wherein the first and second locations are respectively associated with the first and second provider catalogs.

19. A method of accessing a selected product catalog for a selected funerary service provider among a plurality of funerary service providers, the method comprising:
(a) accessing a provider profile data structure associated with the selected funerary service provider, wherein the provider profile data structure is among a plurality of provider profile data structures, each provider profile data structure configured to define at least one provider catalog for an associated funerary service provider from among the plurality of funerary service providers, each provider profile data structure identifying for inclusion in the provider catalog defined thereby a subset of a plurality of funerary items stored in a common database, and each provider profile data structure further identifying provider-specific pricing information for at least a subset of the funerary items identified in the provider catalog defined thereby; and
(b) accessing offering information from the provider catalog for the selected funerary service provider using the provider profile data structure associated with the selected funerary service provider.

20. The method of claim 19, wherein at least one provider profile data structure further identifies for the provider catalog defined thereby at least one additional provider-specific funerary item that is not stored in the database.

21. The method of claim 19, wherein accessing the offering information is performed during interaction with a customer when creating a funeral plan for that customer to display a portion of the provider catalog to the customer after selection of the selected funerary service provider by the customer.

22. The method of claim 21, further comprising selecting the selected funerary service provider in response to customer input subsequent to a search of funerary service providers.

23. The method of claim 21, further comprising selecting the selected funerary service provider based upon an identifier provided in a URL.

24. The method of claim 21, wherein accessing the offering information is performed during administration of the provider profile data structure for the selected first funerary service provider in response to user input from an authorized user for the selected funerary service provider.

25. The method of claim 19, wherein the provider profile data structure for a first funerary service provider further identifies at least one package, the package identifying a subset of items from the provider catalog defined by the provider profile data structure, and a package price for the subset of items from the provider catalog.

26. The method of claim 25, wherein the provider profile data structure for the selected funerary service provider identifies a plurality of packages, the method further comprising accessing the provider profile data structure for the selected funerary service provider during creation of a funeral plan for a customer, and generating therefrom a list of packages for selection by the customer for incorporation into the funeral plan.

27. The method of claim 25, further comprising accessing the provider profile data structure for the selected funerary service provider when creating or modifying the package in response to user input from an authorized user for the selected funerary service provider.

28. The method of claim 25, wherein the package identifies at least one item classification such that a customer is permitted to obtain any of a plurality of items matching the item classification for inclusion in the package.

29. The method of claim 19, wherein the provider profile data structure for the selected funerary service provider identifies first and second provider catalogs, the first and second provider catalogs respectively associated with first and second groups, the first and second provider catalogs differing from one another based upon at least one of the subsets of items and provider-specific pricing information identified thereby.

30. The method of claim 29, wherein the provider profile data structure for the selected funerary service provider further identifies first and second locations, wherein the first and second locations are respectively associated with the first and second provider catalogs.

31. A program product, comprising:
(a) a plurality of provider profile data structures respectively configured to define at least one provider catalog for each of a plurality of funerary service providers, each provider profile data structure identifying a subset of a plurality of funerary items from a common database to be included in the provider catalog defined thereby, each provider profile data structure further identifying provider-specific pricing information for at least a subset of the funerary items identified in the provider catalog defined thereby;
(b) program code configured to access the provider catalog for each funerary service provider by accessing the provider profile data structure associated with such funerary service provider; and
(c) a signal bearing medium bearing the plurality of provider profile data structures and the program code.

32. An apparatus, comprising:
(a) a memory storing a plurality of provider profile data structures respectively configured to control a display configuration of a multi-provider funerary web site for each of a plurality of funerary service providers, a first provider profile data structure defining a plurality of entities falling within an organizational structure of a first funerary service provider, and defining a plurality of branding groups identifying a plurality of unique display configurations, wherein the first provider profile data structure associates each entity with a branding group from among the plurality of branding groups; and
(b) program code configured to retrieve a display configuration for a selected entity in the organizational structure of the first funerary service provider by accessing the provider profile data structure associated therewith to retrieve the display configuration associated for the branding group with which the selected entity is associated.

33. The apparatus of claim 32, wherein the first funerary service provider comprises a funeral home company, and wherein each of the plurality of entities comprises a funeral home location.

34. The apparatus of claim 32, wherein the display configuration for the branding group of the selected entity includes at least one of a style sheet and a custom logo.

35. The apparatus of claim 32, wherein the funerary web site comprises a funeral planner web site, wherein the program code comprises funeral planner program code configured to interact with a customer to create a funeral plan for that customer, the funeral planner program code configured to format at least one web page displayed to the customer during creation of the funeral plan according to the retrieved display configuration for the selected entity, after selection of the selected entity by the customer.

36. The apparatus of claim 35, wherein the program code is configured to determine the selection of the selected entity by the customer using a URL supplied to the funeral planner web site as a result of navigation by the customer to the funeral planner web site from a link on a different web site associated with the selected entity.

37. The apparatus of claim 32, wherein the program code is further configured to access the display configuration for the selected entity when creating or modifying the provider profile data structure in response to user input from an authorized user for the first funerary service provider.

38. A method of retrieving a display configuration for a selected entity among a plurality of entities defined in an organizational structure of a selected funerary service provider among a plurality of funerary service providers, the method comprising:
(a) accessing a selected provider profile data structure associated with the selected funerary service provider to determine a selected branding group from among a plurality of branding groups for the selected entity, wherein the provider profile data structure is among a plurality of provider profile data structures, each provider profile data structure respectively configured to control a display configuration of a multi-provider funerary web site an associated funerary service provider from among the plurality of funerary service providers, the selected provider profile data structure defining a unique display configuration for each of the plurality of branding groups, wherein the selected provider profile data structure associates each entity with a branding group from among the plurality of branding groups; and
(b) retrieving the display configuration for the selected entity by accessing the selected provider profile data structure to retrieve the display configuration associated with the selected branding group.

39. The method of claim 38, wherein the first funerary service provider comprises a funeral home company, and wherein each of the plurality of entities comprises a funeral home location.

40. The method of claim 38, wherein the display configuration for the branding group of the selected entity includes at least one of a style sheet and a custom logo.

41. The method of claim 38, wherein the funerary web site comprises a funeral planner web site, the method further comprising receiving user input from a customer to create a funeral plan for that customer, and generating, during creation of the funeral plan, formatting at least one web page to be displayed to the customer according to the retrieved display configuration for the selected entity.

42. The method of claim 41, further comprising determining the selection of the selected entity by the customer using a URL supplied to the funeral planner web site as a result of navigation by the customer to the funeral planner web site from a link on a different web site associated with the selected entity.

43. The method of claim 38, further comprising retrieving the display configuration for the selected entity when creating or modifying the provider profile data structure in response to user input from an authorized user for the first funerary service provider.

44. A method of creating a funeral plan, the method comprising:
(a) selecting a funeral home with which to associate a funeral plan, wherein the funeral home is among a plurality of funeral homes defined in an organizational structure for a funeral home company;
(b) accessing a provider profile data structure associated with the selected funeral home to determine a branding group from among a plurality of branding groups associated with the funeral home company;
(c) retrieving from the provider profile data structure a display configuration associated with the determined branding group; and
(d) creating a funeral plan for a customer by displaying a sequence of web pages to the customer and receiving user input from the customer, wherein displaying the sequence of web pages includes formatting each web page in the sequence according to the retrieved display configuration for the determined branding group.

45. The method of claim 44, wherein creating the funeral plan further includes:
(a) displaying, on at least one web page among the sequence of web pages, at least a portion of a provider catalog associated with the funeral home company, the provider catalog identifying a plurality of funerary items; and
(b) including in the funeral plan at least one funerary item from the provider catalog in response to user input from the customer.

46. The method of claim 45, wherein the funeral home company is a selected funeral home company among a plurality of funeral home companies with which provider profile data structures are associated, wherein each provider profile data structure further defines at least one provider catalog for the associated funeral home company, each provider catalog identifying a subset of a plurality of funerary items stored in a common database, and each provider profile data structure further identifying provider-specific pricing information for at least a subset of the funerary items identified in the provider catalog defined thereby.

47. The method of claim 45, further comprising determining a selected provider catalog for the selected funeral home by identifying a selected catalog group from among a plurality of catalog groups associated with the funeral home company, wherein the selected provider catalog is among a plurality of provider catalogs associated with the funeral home company, wherein displaying the portion of the provider catalog includes accessing the selected provider catalog.

48. The method of claim 47, wherein the selected catalog group further defines a package identifying a subset of items from the selected provider catalog, the package further identifying a package price for the subset of items from the selected provider catalog, wherein creating the funeral plan further includes including the package in the funeral plan in response to user input from the customer.

49. The method of claim 44, further comprising performing a funeral home search during creation of the funeral home plan, but after select the selected funeral home, including:
(a) accessing a database of funeral home locations to generate a result set that identifies at least one funeral home location meeting a geographic search criterion input by the customer; and
(b) thereafter filtering the search results according to an exclusion criterion associated with the at least one of the funeral home company and the selected funeral home.

50. A method of administering profile information in a provider profile data structure for a selected funeral home company, wherein the provider profile data structure is among a plurality of provider profile data structures stored in a database for a plurality of funeral home companies, wherein the profile information includes at least one of a display configuration and a provider catalog of funerary items, and wherein the selected funeral home company includes an plurality of funeral homes, the method comprising:
(a) displaying first, second and third company structure options to an authorized user for the funeral home company, the first company structure option for defining the profile information as funeral home-specific profile information, the second company structure option for defining the profile information as company-wide profile information, and the third company structure option for defining the profile information as group-based profile information;
(b) in response to selection of the first company structure option by the authorized user, displaying a first administration web page configured to manage administration of the profile information on a funeral home by funeral home basis;
(b) in response to selection of the second company structure option by the authorized user, displaying a second administration web page configured to manage administration of the profile information on a funeral home company-wide basis; and
(c) in response to selection of the third company structure option by the authorized user, displaying a third administration web page configured to manage administration of the profile information on a group by group basis, the third administration web page further configured to manage a group organization for the funeral home company.

51. An apparatus, comprising:
(a) a database storing item information regarding a plurality of funerary items;
(b) a plurality of provider profile data structures respectively configured to define at least one provider catalog for each of a plurality of funerary service providers, each provider profile data structure identifying a subset of the plurality of funerary items from the database to be included in the provider catalog defined thereby, a first provider profile data structure defining a plurality of entities falling within an organizational structure of a first funerary service provider, and defining a plurality of provider catalogs identifying unique subsets of items from the database, wherein the first provider profile data structure associates each entity with at least one provider catalog from among the plurality of provider catalogs; and
(c) program code configured to access the provider catalog associated with a selected entity in the organizational structure of the first funerary service provider by accessing the provider profile data structure associated therewith.

52. The apparatus of claim 51, wherein the first funerary service provider comprises a funeral home company, and wherein each of the plurality of entities comprises a funeral home location.

53. The apparatus of claim 51, wherein the first provider profile data structure further identifies catalog-specific pricing information for each provider catalog associated with the first provider profile data structure.

54. The apparatus of claim 51, wherein the first provider profile data structure further defining at least one package identifying a subset of items from a selected provider catalog, the package further identifying a package price for the subset of items from the selected provider catalog.

55. The apparatus of claim 51, wherein the program code comprises funeral planner program code configured to interact with a customer to create a funeral plan for that customer, the funeral planner program code configured to access the provider catalog associated with the selected entity package after selection of the selected entity by the customer.

56. The apparatus of claim 51, wherein the program code is further configured to access the provider catalog associated with the selected entity when creating or modifying the product catalog in response to user input from an authorized user for the first funerary service provider.

57. The apparatus of claim 51, wherein each product catalog is associated with a group, and wherein each entity is associated with a provider catalog by associating that entity with a group identifier for the group with which such provider catalog is associated.

58. The apparatus of claim 51, wherein the provider profile data structure further identifies for at least one provider catalog defined thereby at least one additional provider-specific funerary item that is not stored in the database.

59. A method of accessing a product catalog for a selected entity among a plurality of entities defined in an organizational structure of a selected funerary service provider among a plurality of funerary service providers, the method comprising:
(a) accessing a selected provider profile data structure associated with the selected funerary service provider, wherein the provider profile data structure is among a plurality of provider profile data structures, each provider profile data structure configured to define at least one provider catalog for an associated funerary service provider from among the plurality of funerary service providers, each provider profile data structure identifying for inclusion in the provider catalog defined thereby a subset of a plurality of funerary items stored in a common database, the selected provider profile data structure defining a plurality of provider catalogs identifying unique subsets of items from the database, wherein the selected provider profile data structure associates each entity with at least one provider catalog from among the plurality of provider catalogs; and
(b) accessing the provider catalog associated with the selected entity in the organizational structure of the first funerary service provider by accessing the provider profile data structure associated therewith.

60. The method of claim 59, wherein the first funerary service provider comprises a funeral home company, and wherein each of the plurality of entities comprises a funeral home location.

61. The method of claim 59, wherein the first provider profile data structure further identifies catalog-specific pricing information for each provider catalog associated with the first provider profile data structure.

62. The method of claim 59, wherein the first provider profile data structure further defines at least one package identifying a subset of items from a selected provider catalog, the package further identifying a package price for the subset of items from the selected provider catalog.

63. The method of claim 59, wherein each product catalog is associated with a group, and wherein each entity is associated with a provider catalog by associating that entity with a group identifier for the group with which such provider catalog is associated.

64. The method of claim 59, wherein the provider profile data structure further identifies for at least one provider catalog defined thereby at least one additional provider-specific funerary item that is not stored in the database.

65. A method of locating a funeral home, the method comprising:
(a) accessing a database of funeral home locations to generate a result set that identifies at least one funeral home location meeting a geographic search criterion; and
(b) thereafter filtering the search results according to an exclusion criterion associated with a funerary services provider.

66. The method of claim 65, wherein the exclusion criterion includes a geographic exclusion criterion associated with a location of the funerary services provider.

67. The method of claim 66, wherein the exclusion criterion identifies at least one of a ZIP code, an area code, a state, a city, and a county within which funeral home locations identified in the result set are to be excluded from the filtered search results.

68. The method of claim 66, wherein accessing the database of funeral home locations is performed during creation of a funeral plan by a customer on a funeral plan web site, and subsequent to the customer navigating to the funeral plan web site from a funeral home web site associated with the funerary services provider.

69. An apparatus, comprising:
(a) a database identifying a plurality of funeral home locations; and
(b) program code configured to access the database to generate a result set that identifies at least one funeral home location meeting a geographic search criterion, and to thereafter filter the search results according to an exclusion criterion associated with a funerary services provider.

70. The apparatus of claim 69, wherein the exclusion criterion includes a geographic exclusion criterion associated with a location of the funerary services provider.

71. The apparatus of claim 69, wherein the exclusion criterion identifies at least one of a ZIP code, an area code, a state, a city, and a county within which funeral home locations identified in the result set are to be excluded from the filtered search results.

72. The apparatus of claim 69, wherein the program code is configured to access the database of funeral home locations during creation of a funeral plan by a customer on a funeral plan web site, and subsequent to the customer navigating to the funeral plan web site from a funeral home web site associated with the funerary services provider.

73. An apparatus, comprising:
(a) a database storing item information regarding a plurality of funerary items;
(b) a plurality of provider profile data structures respectively configured to define at least one provider catalog for each of a plurality of funerary service providers, each provider profile data structure identifying a subset of the plurality of funerary items from the database to be included in the provider catalog defined thereby, at least one provider profile data structure further defining at least one package identifying a subset of items from the provider catalog defined thereby, the package further identifying a package price for the subset of items from the provider catalog; and
(c) program code configured to access the package by accessing the provider profile data structure associated therewith.

74. The apparatus of claim 73, wherein each provider profile data structure further identifies provider-specific pricing information for at least a subset of the funerary items identified in the provider catalog defined thereby, and wherein the package price specifies a discount from an ala carte price generated from the provider-specific pricing information for the subset of items identified by the package.

75. The apparatus of claim 74, wherein the discount is based upon a specified percentage of the ala carte price.

76. The apparatus of claim 73, wherein the program code comprises funeral planner program code configured to interact with a customer to create a funeral plan for that customer, the funeral planner program code configured to access the package to display a portion of the package to the customer during creation of the funeral plan.

77. The apparatus of claim 73, wherein the package is associated with a first funerary services provider, and wherein the program code is further configured to access the provider profile data structure associated with the first funerary services provider when creating or modifying the package in response to user input from an authorized user for the first funerary service provider.

78. The apparatus of claim 77, wherein at least one item from the subset of items identified by the package is identified in the provider profile data structure for the first funerary service provider as being displayable only in connection with the package such that the item is not separately selectable by a customer when viewing the provider catalog for the first funerary service provider.

79. The apparatus of claim 73, wherein the package identifies at least one item classification such that a customer is permitted to obtain any of a plurality of items matching the item classification for inclusion in the package.

80. The apparatus of claim 79, wherein the package further identifies at least one default item for the item classification.

81. A method of accessing a selected package for a selected funerary service provider among a plurality of funerary service providers, the method comprising:
(a) accessing a provider profile data structure associated with the selected funerary service provider, wherein the provider profile data structure is among a plurality of provider profile data structures, each provider profile data structure configured to define at least one provider catalog for an associated funerary service provider from among the plurality of funerary service providers, each provider profile data structure identifying for inclusion in the provider catalog defined thereby a subset of a plurality of funerary items stored in a common database, the provider profile data structure associated with the selected funerary service provider further defining at least one package identifying a subset of items from the provider catalog defined thereby, the package further identifying a package price for the subset of items from the provider catalog; and
(b) accessing offering information from the package for the selected funerary service provider using the provider profile data structure associated with the selected funerary service provider.

82. The method of claim 81, wherein each provider profile data structure further identifies provider-specific pricing information for at least a subset of the funerary items identified in the provider catalog defined thereby, and wherein the package price specifies a discount from an ala carte price generated from the provider-specific pricing information for the subset of items identified by the package.

83. The method of claim 82, wherein the discount is based upon a specified percentage of the ala carte price.

84. The method of claim 81, wherein accessing the package is performed during interaction with a customer when creating a funeral plan for that customer.

85. The method of claim 81, wherein accessing the provider profile data structure associated with the selected funerary services provider is performed when creating or modifying the package in response to user input from an authorized user for the selected funerary service provider.

86. The method of claim 85, wherein at least one item from the subset of items identified by the package is identified in the provider profile data structure for the selected funerary service provider as being displayable only in connection with the package such that the item is not separately selectable by a customer when viewing the provider catalog for the selected funerary service provider.

87. The method of claim 81, wherein the package identifies at least one item classification such that a customer is permitted to obtain any of a plurality of items matching the item classification for inclusion in the package.

88. The method of claim 87, wherein the package further identifies at least one default item for the item classification.
